(19) United States
(12) Patent Application Publication
(10) Pub. No.: US 2026/0046103 A1
(43) Pub. Date: Feb. 12, 2026

(54) PHYSICAL RANDOM ACCESS CHANNEL (PRACH) FOR SUBBAND FULL DUPLEX OPERATION

(71) Applicant: Telefonaktiebolaget LM Ericsson (publ), Stockholm (SE)

(72) Inventors: Stephen GRANT, Pleasanton, CA (US); Jung-Fu CHENG, Fremont, CA (US); Peter ALRIKSSON, Hörby (SE)

(21) Appl. No.: 19/100,673

(22) PCT Filed: Aug. 11, 2023
(86) PCT No.: PCT/SE2023/050816

§ 371 Date: Feb. 3, 2025

Related U.S. Application Data
(60) Provisional application No. 63/397,732, filed on Aug. 12, 2022.

(51) Int. Cl. H04L 5/14; H04W 72/0453; H04W 72/20; H04W 74/0833

(52) U.S. Cl. CPC H04L 5/14; H04W 72/0453; H04W 72/20; H04W 74/0833

(57) ABSTRACT

A method, network node and wireless device (WD) for a physical random access channel (PRACH) for subband full duplex operation are disclosed. According to one aspect, a wireless device configured to communicate with a network node is provided. The wireless device is configured to receive frequency domain configuration information and time domain configuration information indicating a plurality of subband full duplex, SBFD, symbols and a plurality of uplink-, UL-, only symbols in a time division duplex, TDD, configuration, and determine a validity of a random access channel, RACH, occasion, RO, based on whether a validity condition is met, the RO being positioned in at least one SBFD symbol of the plurality of SBFD symbols or in at least one UL-only symbol of the plurality of UL-only symbols.

### TECHNICAL FIELD

The present disclosure relates to wireless communications, and in particular, to a physical random access channel for subband full duplex operation.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Sixth Generation (6G) wireless communication systems are also under development.

3GPP NR may be designed to provide service for multiple use cases such as enhanced mobile broadband (eMBB), ultra-reliable and low latency communication (URLLC), and machine type communication (MTC). Each of these services has different technical requirements. For example, the general requirement for evolved mobile broadband (eMBB) is high data rate with moderate latency and moderate coverage, while ultra-reliable and low latency (URLLC) service requires a low latency and high reliability transmission but perhaps for moderate data rates.

One of the solutions for low latency data transmission is shorter transmission time intervals. In NR in addition to transmission in a slot, a mini-slot transmission is also allowed to reduce latency. A mini-slot may include any number of 1 to 14 orthogonal frequency division multiplexed (OFDM) symbols, as illustrated in FIG. 1. It should be noted that the concepts of slot and mini-slot are not specific to a specific service meaning that a mini-slot may be used for either eMBB, URLLC, or other services.

In 3GPP Technical Release 15 (3GPP Rel-15) NR, a WD may be configured with up to four carrier bandwidth parts in the downlink with a single downlink carrier bandwidth part being active at a given time. A WD may be configured with up to four carrier bandwidth parts in the uplink with a single uplink carrier bandwidth part being active at a given time.

A 3GPP NR slot includes several OFDM symbols. According to current agreements, a slot includes either 7 or 14 symbols for an OFDM subcarrier spacing ≤60 kHz, and a slot includes 14 symbols for an OFDM subcarrier spacing >60 kHz. FIG. 2 shows a subframe with 14 OFDM symbols. In FIG. 2, Tₛ and T_{symb} denote the slot and OFDM symbol duration, respectively.

Transmission and reception from a node, e.g., a terminal in a cellular system, may be multiplexed in the frequency domain or in the time domain (or combinations thereof). Frequency Division Duplex (FDD) as illustrated to the left in FIG. 3, implies that downlink and uplink transmission take place in different, sufficiently separated, frequency bands. Time Division Duplex (TDD), as illustrated to the right in FIG. 3, implies that downlink and uplink transmission take place in different, non-overlapping time slots. Thus, TDD may operate in unpaired spectrum, whereas FDD requires paired spectrum.

Typically, the structure of the transmitted signal in a communication system is organized in the form of a frame structure. For example, NR uses ten equally-sized slots per radio frame, as illustrated in FIG. 4 for the case of 15 kHz subcarrier spacing.

For FDD operation (upper part of FIG. 4), there are two carrier frequencies, one for uplink transmission (f_{UL}) and one for downlink transmission (f_{DL}). At least with respect to the terminal in a cellular communication system, FDD may be either full duplex or half duplex. In the full duplex case, a terminal may transmit and receive simultaneously, while in half-duplex operation, the terminal cannot transmit and receive simultaneously (although the base station is capable of simultaneous reception and transmission, e.g., receiving from one terminal while simultaneously transmitting to another terminal). In LTE, a half-duplex terminal is monitors and receives in the downlink except when explicitly being instructed to transmit in a certain subframe.

For TDD operation (lower part of FIG. 4), there is only a single carrier frequency and uplink and downlink transmissions are always separated in time and on a cell basis. As the same carrier frequency is used for uplink and downlink transmission, both the base station and the mobile terminals need to switch from transmission to reception and vice versa. An aspect of any TDD system is to provide the possibility for a sufficiently large guard time where neither downlink nor uplink transmissions occur. This is required to avoid interference between uplink and downlink transmissions. For NR, this guard time is provided by special subframes, which are split into three parts: symbols for DL, a guard period (GP), and symbols for uplink. The remaining subframes are either allocated to uplink or downlink transmission.

In more detail, the following two information elements (IEs) are defined in current specifications. The TDD pattern is typically configured with at least the first IE and optionally the 2^{nd} IE:
TDD-DL-UL-ConfigCommon (cell-specific); and
TDD-DL-UL-ConfigDedicated (UE-specific).

The first IE is cell specific (common to all WDs) and is provided by broadcast signaling. It provides the number of slots in the TDD pattern via a reference subcarrier spacing and a periodicity such that the S-slot pattern repeats every S slots. This IE allows for very flexible configuration of the pattern characterized by one or more of the following parameters:
A number of full downlink slots at the beginning of the pattern configured by the parameter nDownlinkSlots;
A number of full uplink slots at the end of the pattern configured by the parameter nUplinkSlots;
A number of downlink (‘D’) symbols following the full downlink slots configured by the parameter nDownlinkSymbols;
A number of uplink (‘U’) symbols preceding the full downlink slots configured by the parameter nUplinkSlots;
If there is a gap between the last downlink symbol and the first uplink symbol, then all symbols in the gap are characterized as flexible (‘F’). A symbol classified as ‘F’ may be used for downlink or uplink. A WD determines the direction in one of the following two ways:
   Detecting downlink control information (DCI) that schedules/triggers a DL signal/channel, e.g., PDSCH, CSI-RS or schedules/triggers an UL signal/channel, e.g., PUSCH, SRS, etc.; and/or
   By dedicated (WD-specific) signaling of the IE TDD-DL-UL-ConfigDedicated. This parameter overrides some or all of the ‘F’ symbols in the pattern, thus providing a semi-static indication of whether a symbol is classified as ‘D’ or ‘U’; and/or
Optionally, a 2^{nd} pattern that is concatenated to the first pattern may be configured as above. If a 2^{nd} pattern is configured, the constraint is that the sum of the periodicities of the two patterns must evenly divide 20 ms.

FIG. 5 shows an example TDD DL/UL pattern configured by TDD-DL-UL-ConfigCommon. It includes 3 full ‘D’ slots and 1 full ‘U’ slot, with a mixed slot in between including 4 ‘D’ symbols and 3 ‘U’ symbols. The remaining 7 symbols in the mixed slot are classified as ‘F.’

Stiff referring to FIG. 5, if a WD is not configured with TDD-DL-UL-ConfigDedicated, then the pattern at the top of the diagram is assumed. As stated above, the network may make use of the ‘F’ symbols flexibly, by scheduling or triggering either an uplink or a downlink signal and/or channel in a WD specific manner. This allows for very dynamic behavior. The direction is not known to the WD a priori; rather, the direction becomes known once the WD detects a DCI scheduling/triggering a particular DL or UL signal/channel.

In contrast, the DL/UL direction for some or all of the ‘F’ symbols in a particular slot may be provided to the WD in a semi-static manner by radio resource control (RRC) signaling that configures the WD with TDD-DL-UL-ConfigDedicated. The lower part of FIG. 5 shows 3 example configurations for overriding ‘F’ symbols in Slot 3. If the IE indicates ‘allDownlink’ or ‘allUplink’ for a particular slot (or slots), then all ‘F’ symbols in the slot are converted to either ‘D’ or ‘U,’ respectively. If the IE indicates ‘explicit,’ then a number of symbols at the beginning of the slot and/or a number of symbols at the end of the slot are indicated as ‘D’ and ‘U,’ respectively. In the example below, the first 7 and the last 5 are indicated as ‘D’ and ‘U’, which converts some of the ‘F’ symbols to ‘D’ and ‘U,’ for example.

A behavior in the above is that the WD-specific IE TDD-DL-UL-ConfigDedicated may only override (i.e., specify ‘D’ or ‘U’) for symbols that are configured as ‘F’ by the cell-specific IE TDD-DL-UL-ConfigCommon. In other words, a WD does not expect to have a ‘D’ symbol converted to ‘U’ or vice versa.

FIG. 6 shows three additional example TDD DL/UL patterns configured by TDD-DL-UL-ConfigCommon. In the first and second patterns, there are no ‘F’ symbols. Hence, according to current behavior in the 3GPP Rel-17 specifications, the WD would not expect to be configured with TDD-DL-UL-ConfigDedicated. In the second pattern, all symbols in Slots 1, 2, and 3 are configured as ‘F.’ Hence, the WD may be configured with TDD-DL-UL-ConfigDedicated to provide a direction (‘D’ or ‘U’) for any or all symbols in these 3 slots. Note that the current (3GPP Rel-17) specifications allow the dedicated configuration of the TDD pattern on a slot-specific basis. In other words, TDD-DL-UL-ConfigDedicated is not restricted to be the same in each slot where ‘F’ symbols are overridden.

### Subband Full Duplex

As described above, in a conventional TDD system, entire carrier BW or all carriers in the same frequency band need to be utilizing the same DL transmission or UL reception directions. This is further illustrated in FIG. 7.

For the 3GPP Rel-18 evolution of the NR system, 3GPP has decided to study the technical feasibilities and potential benefits of subband full duplex (SBFD) systems.

In such a system, a portion of a wide bandwidth carrier may be used for a different direction than that of the rest of the carrier. This is illustrated in the left-hand side of FIG. 8. That is, unlike a conventional TDD system as shown on the left-hand side of FIG. 8 where the entire bandwidth is used for DL transmission in the first three slots, the center portion of the SBFD carrier is used for UL reception while the rest of the carrier continues to be used for DL transmission as shown in the left-hand side of FIG. 8.

Similarly, instead of utilizing all carriers for the same DL or UL directions in a conventional TDD system as shown in the right-hand side of FIG. 7 some carriers in the SBFD system may be used for a different direction than that of the other carriers as shown in the right-hand side of FIG. 8

In the 3GPP Rel-18 study, the scope has been limited such that in subband frequency domain (SBFD) operation, only network nodes (e.g., gNBs) transmit downlink (DL) and receive uplink (UL) simultaneously. An individual WD is scheduled in only one direction (DL or UL) at a time.

Methods for configuration of one or more OFDM symbols of a slot with two or more resource block (RB) sets, where each RB set corresponds to a frequency domain subband and has a defined transmission direction (‘D’ or ‘U’), have been disclosed. The RB sets may have gaps between them that serve as guard bands where neither DL or UL transmission occurs. FIGS. 9 and 10 show two example RB set configurations, one with D-U-D configuration and the other with U-D-U configuration. The RB sets are configured either by introduction of new RRC parameter(s) or enhancement of an existing RRC parameter, e.g., TDD-UL-DL-ConfigDedicated. In either case, the parameter(s) signal the size and frequency domain location of the RB sets as well as which symbols/slots in the TDD UL/DL pattern are configured with RB sets.

### Advanced Antenna Arrays for TDD Systems

Modern cellular wireless communication systems utilize advance antenna array systems to perform beamforming and multiple input multiple output (MIMO) transmission in order to enhance the coverage and throughput of the system. A generic example antenna array for a TDD system is illustrated in FIG. 11. In such an example array, multiple antenna elements are utilized and typically placed in a planar array with horizontal and vertical spacings suitable for the operating frequency bands. For a TDD base station, the antenna array is connected to a TX/RX switch such that the same antenna array may be used for transmitting DL signals in a DL slot as well as used for receiving UL signals in an UL slot

### Antenna Architecture I for SBFD Systems

In an SBFD system, the base station will need to perform DL transmission and UL reception simultaneously. It hence becomes necessary to utilize two antenna arrays for the two directions, respectively as illustrated in FIG. 12:
A first antenna array is utilized for UL reception only; and
A second antenna array is utilized for DL transmission only.

It is also generally necessary to introduce additional isolation material or mechanisms between the two antenna arrays to suppress the signal leaking from the TX array into the RX array Without such isolation, the UL receiver may be de-sensitized due to the fact that the DL transmit power is generally much higher than the UL receive power.

### PRACH Configuration

An example physical random access channel (PRACH) configuration according to existing (3GPP Rel-17) specifications is described here. The example is for frequency range 1 (FR1) for unpaired spectrum, and uses PRACH configuration index 118 from 3GPP Rel-17 of 3GPP Technical Standard (TS) 38.211 as follows:

TABLE 6.3.3.2-3
Random access configurations for FR1 and unpaired spectrum.

| | | | | | | | Nₜ^{RA, slot}, | |
|---|---|---|---|---|---|---|---|---|
| | | | | | | | number | |
| | | | | | | | of time- | |
| | | | | | | | domain | |
| | | | | | | Number of | PRACH | |
| | | | | | | PRACH | occasions | |
| PRACH | | n_{f} mod | | | | slots | within a | N_{dur}^{RA}, |
| Configuration | Preamble | x = y | | Subframe | Starting | within a | PRACH | PRACH |
| Index | format | x | y | number | symbol | subframe | slot | duration |
| 118 | A3 | 2 | 1 | 2, 3, 4, | 0 | 1 | 2 | |
| | | | | 7, 8, 9 | | | | |

FIG. 13 illustrates the example PRACH configuration assuming the PRACH SCS is 30 kHz. The value x=1 in Table 6.3.3.2-3 above means that the PRACH configuration period is 2 radio frames (20 ms), and the value y=1 means that the RACH occasions (ROs) occur in the 21^{d} frame of this period. Within this frame, the ROs occur in subframes 2, 3, 4, 7, 8, and 9. With 30 kHz SCS, there are two slots per subframe. Since the number of PRACH slots within a subframe is equal to 1 for this example, the 2^{nd} slot of the subframe contains the ROs according to current specifications. This means that the ROs are contained in slots 5, 7, 9, 15, 17, and 19. In this example, PRACH format A3 (6 symbol duration) is used. Hence, there are two back-to-back ROs per slot starting at symbol 0 of the slot.

For this example, assume that the cell-specific (common) TDD UL/DL pattern is D-D-D-D-U, which is also shown in FIG. 13. In the existing 3GPP TS 38.213 specification, the WD assumes that a RACH occasion is valid if it is within UL symbols according to the following text extract:

### [3GPP TS 38.213 Section 8.1]

For unpaired spectrum,
   if a WD is not provided tdd-UL-DL-ConfigurationCommon, a PRACH occasion in a PRACH slot is valid if it does not precede a SS/PBCH block in the PRACH slot and starts at least N_{gap} symbols after a last SS/PBCH block reception symbol, where N_{gap} is provided in Table 8.1-2 and, if channelAccessMode=“semiStatic” is provided, does not overlap with a set of consecutive symbols before the start of a next channel occupancy time where the WD does not transmit [15, TS 37.213].
      the candidate SS/PBCH block index of the SS/PBCH block corresponds to the SS/PBCH block index provided by ssb-PositionsInBurst in SIB1 or in ServingCellConfigCommon, as described in clause 4.1
   If a WD is provided tdd-UL-DL-ConfigurationCommon, a PRACH occasion in a PRACH slot is valid if
      it is within UL symbols, or
      it does not precede a SS/PBCH block in the PRACH slot and starts at least N_{gap} symbols after a last downlink symbol and at least N_{gap} symbols after a last SS/PBCH block symbol, where N_{gap} is provided in Table 8.1-2, and if channelAccessMode=“semiStatic” is provided, does not overlap with a set of consecutive symbols before the start of a next channel occupancy time where there shall not be any transmissions, as described in [15, TS 37.213]
      the candidate SS/PBCH block index of the SS/PBCH block corresponds to the SS/PBCH block index provided by ssb-PositionsInBurst in SIB1 or in ServingCellConfigCommon, as described in clause 4.1.

With the D-D-D-D-U pattern, it turns out that only slots 9 and 19 contain valid ROs. The ROs in slots in 5, 7, 15, and 17 are invalidated, as indicated by the X's in FIG. 13.

According to 3GPP TS 38.331, ROs are configured in the frequency domain via two parameters: msg1-FDM which indicates the number of ROs in the frequency domain (1, 2, 4, or 8) within an OFDM symbol, and msg1-FrequencyStart which indicates the lowest indexed RB in the active BWP of the first RO in the frequency domain.

RACH-ConfigGeneric information element

| | |
|---|---|
| RACH-ConfigGeneric ::= | SEQUENCE { |
| prach-ConfigurationIndex | INTEGER (0..255), |
| msg1-FDM | ENUMERATED {one, two, |
| | four, eight}, |
| msg1-FrequencyStart | INTEGER |

(0..maxNrofPhysicalResourceBlocks−1),

| | |
|---|---|
| zeroCorrelationZoneConfig | INTEGER(0..15), |
| preambleReceivedTargetPower | INTEGER |
| | (−202..−60), |

RACH-ConfigGeneric information element

| | |
|---|---|
| RACH-ConfigGeneric ::= | SEQUENCE { |
| prach-ConfigurationIndex | INTEGER (0..255), |
| msg1-FDM | ENUMERATED {one, two, |
| | four, eight}, |
| msg1-FrequencyStart | INTEGER |

(0..maxNrofPhysicalResourceBlocks−1),

| | |
|---|---|
| zeroCorrelationZoneConfig | INTEGER(0..15), |
| preambleReceivedTargetPower | INTEGER |
| | (−202..−60), |

```
  ...
  }
```

According to 3GPP TS 38.331, a configurable number of SSBs are mapped to the ROs defined in the time and frequency domains. This is controlled by the RRC parameter ssb-perRACH-OccasionAndCB-PreamblesPerSSB as shown in the following:

RACH-ConfigGeneric field descriptions
msg1-FDM
The number of PRACH transmission occasions FDMed in one time
instance. (see 3GPP TS 38.211 [16], clause 6.3.3.2).
msg1-FrequencyStart
Offset of lowest PRACH transmission occasion in frequency domain
with respective to PRB 0. The value is configured so that the corresponding
RACH resource is entirely within the bandwidth of the UL BWP. (see 3GPP TS
38.211 [16], clause 6.3.3.2).

RACH-ConfigCommon information element

| | |
|---|---|
| RACH-ConfigCommon ::= | SEQUENCE { |

| | |
|---|---|
| rach-ConfigGeneric | RACH-ConfigGeneric, |

| | |
|---|---|
| totalNumberOfRA-Preambles | INTEGER (1..63) |

OPTIONAL, -- Need S
ssb-perRACH-OccasionAndCB-PreamblesPerSSB CHOICE {

| | |
|---|---|
| oneEighth | ENUMERATED |

{n4,n8,n12,n16,n20,n24,n28,n32,n36,n40,n44,n48,n52,n56,n60,n64},

| | |
|---|---|
| oneFourth | ENUMERATED |

{n4,n8,n12,n16,n20,n24,n28,n32,n36,n40,n44,n48,n52,n56,n60,n64},

| | |
|---|---|
| oneHalf | ENUMERATED |

{n4,n8,n12,n16,n20,n24,n28,n32,n36,n40,n44,n48,n52,n56,n60,n64},

| | |
|---|---|
| one | ENUMERATED |

{n4,n8,n12,n16,n20,n24,n28,n32,n36,n40,n44,n48,n52,n56,n60,n64},

| | |
|---|---|
| two | ENUMERATED |

{n4,n8,n12,n16,n20,n24,n28,n32},

| | |
|---|---|
| four | INTEGER (1..16), |
| eight | INTEGER (1..8), |
| sixteen | INTEGER (1..4) |

```
    }
  ...
  }
```

RACH-ConfigCommon field descriptions

ssb-perRACH-OccasionAndCB-PreamblesPer SSB
The meaning of this field is twofold: the CHOICE conveys the
information about the number of SSBs per RACH occasion. Value oneEighth
corresponds to one SSB associated with 8 RACH occasions, value oneFourth
corresponds to one SSB associated with 4 RACH occasions, and so on. The
ENUMERATED part indicates the number of Contention Based preambles per
SSB. Value n4 corresponds to 4 Contention Based preambles per SSB, value n8
corresponds to 8 Contention Based preambles per SSB, and so on. The total
number of CB preambles in a RACH occasion is given by CB-preambles-per-
SSB * max(1, SSB-per-rach-occasion). See 3GPP TS 38.213.

A value of ⅛, ¼, or ½ means that 1 SSB is mapped to either 8, 4 or 2 consecutive ROs, respectively. A value of 1, 2, 4, 8, or 16 means that 1, 2, 4, 8, or 16 SSBs, respectively, are mapped to a single RO. The ordering of SSB to RO mapping is defined in 3GPP TS 38.213, Section 8.1, according to the following text extract:

### [3GPP TS 38.213 Section 8.1]

SS/PBCH block indexes provided by ssb-PositionsInBurst in SIB1 or in ServingCellConfigCommon are mapped to valid PRACH occasions in the following order where the parameters are described in [4, 3GPP TS 38.211].
   First, in increasing order of preamble indexes within a single PRACH occasion
   Second, in increasing order of frequency resource indexes for frequency multiplexed PRACH occasions
   Third, in increasing order of time resource indexes for time multiplexed PRACH occasions within a PRACH slot
   Fourth, in increasing order of indexes for PRACH slots

Essentially, the mapping is performed based on valid ROs, and follows a frequency first, time second ordering. For example, using the above PRACH configuration example with the following additional configuration:
8 SSBs;
msg1-FDM=4; and
ssb-perRACH-OccasionAndCB-PreamblesPerSSB ‘one’ results in the SSB-RO mapping shown in FIG. 14.

In this example, the association period is equal to 1, i.e., a complete cycle of SSB indices occurs within a single PRACH configuration period.

### Preamble Received Target Power

In 3GPP TS 38.331, the preamble received target power is configured via the parameter: preambleReceivedTargetPower which indicates the target power level at the receiver side.

RACH-ConfigGeneric information element

| | |
|---|---|
| RACH-ConfigGeneric ::= | SEQUENCE { |
| prach-ConfigurationIndex | INTEGER (0..255), |
| msg1-FDM | ENUMERATED {one, two, four, eight}, |
| msg1-FrequencyStart | INTEGER (0..maxNrofPhysicalResourceBlocks−1), |
| zeroCorrelationZoneConfig | INTEGER(0..15), |
| preambleReceivedTargetPower | INTEGER (−202..−60), |

...
}

RACH-ConfigGeneric field descriptions

preambleReceivedTargetPower
The target power level at the network receiver side (see 3GPP TS 38.213 [13],
clause 7.4, 3GPP TS 38.321 [3], clauses 5.1.2, 5.1.3). Only multiples of 2 dBm
may be chosen (e.g. −202, −200, −198, . . . ).

According to 3GPP TS 38.213, the WD then uses this parameter together with a pathloss estimate and maximum output power computation of the transmission power for the physical random access channel (PRACH).

In the latest (3GPP Rel-17) specifications, there is no support for SBFD operation which is characterized by the provision of UL resources within symbols that are used simultaneously by the gNB for DL transmission. For the case of PRACH, the specifications support PRACH transmission only in UL-only symbols.

### SUMMARY

Some embodiments advantageously provide methods, network nodes and wireless devices (WDs) for a physical random access channel for subband full duplex operation.

Some embodiments include methods to enable PRACH transmissions in both UL-only symbols and SBFD symbols containing a UL frequency subband in which the UL frequency domain resources availability is different in both symbol types. Different approaches are disclosed for (1) determining and/or configuring RACH occasion (RO) validity, (2) mapping of SSB indices to ROs, and (3) determining/configuring the preamble received target power.

Multiple approaches are disclosed for determining/configuring RACH occasion (RO) validity. Some embodiments provide an implicit approach for RO validity determination that extends the current procedure to include a frequency domain condition. Frequency domain ROs are valid if they are completely contained within an UL subband. Frequency domain ROs that are not fully contained within an UL subband are considered invalid. Some embodiments provide approaches that enable separate configuration of the number of ROs and their frequency domain position in SBFD symbols and UL-only symbols.

Some embodiments provide approaches for mapping SSB indices to valid RO. In some embodiments, continuous mapping in a frequency-first/time-second manner is performed over all ROs, regardless of symbol type (SBFD symbols vs. UL-only symbols). In some embodiments, separate mapping is performed in the different symbol types to ensure that all SSB indices are mapped to ROs in both UL-only and SBFD symbols to maximize robustness.

Some embodiments, provide methods for configuring the preamble received target power for ROs in SBFD symbols.

An advantage of enabling PRACH transmission in both UL-only and symbols and SBFD symbols is either or both increased RACH capacity or reduced RACH latency compared to a system in which UL resources are available in UL-only symbols.

According to one aspect of the present disclose, a wireless device configured to communicate with a network node is provided. The wireless device is configured to: receive frequency domain configuration information and time domain configuration information indicating a plurality of subband full duplex, SBFD, symbols and a plurality of uplink-, UL-, only symbols in a time division duplex, TDD, configuration, and determine a validity of a random access channel, RACH, occasion, RO, based on whether a validity condition is met, where the RO is positioned in at least one SBFD symbol of the plurality of SBFD symbols or in at least one UL-only symbol of the plurality of UL-only symbols.

According to one or more embodiments of this aspect, the validity condition defines that the RO is valid based on the RO being positioned within the at least one SBFD symbol or within the at least one UL-only symbol.

According to one or more embodiments of this aspect, the validity condition indicates the RO is valid based on the RO being contained within a bandwidth of an UL subband of the at least one SBFD symbol.

According to one or more embodiments of this aspect, the validity condition indicates that the RO is valid based on all configured ROs in the at least one SBFD symbol being contained within a bandwidth of an UL subband of the at least one SBFD symbol.

According to one or more embodiments of this aspect, the wireless device is further configured to receive a first parameter indicating a number of ROs in the frequency domain within the at least one SBFD symbol.

According to one or more embodiments of this aspect, the wireless device is further configured to receive a second parameter, that indicates a resource block, RB, start index for the RO in the frequency domain within the at least one SBFD symbol.

According to one or more embodiments of this aspect, the first parameter is applicable to both the at least one SBFD symbol and the at least one UL-only symbol, and the second parameter is applicable only to the at least one SBFD symbol.

According to one or more embodiments of this aspect, the first parameter and second parameter are applicable only to the at least one SBFD symbol, and not the at least one UL-only symbol.

According to one or more embodiments of this aspect, the second parameter is an RB offset relative to the RB start index for the RO in the frequency domain within the at least one UL-only symbol.

According to one or more embodiments of this aspect, the wireless device is further configured to determine an RB offset relative to the RB start index for the RO in the frequency domain within the at least one UL-only symbol.

According to one or more embodiments of this aspect, the second parameter is an RB offset relative to a starting RB of an UL subband within the at least one SBFD symbol.

According to one or more embodiments of this aspect, the wireless device is further configured to determine a starting RB during the at least one SBFD symbol based at least one: a starting RB of a starting RO in the at least one UL-only symbol; and a starting RB of an UL subband in the at least one SBFD symbol.

According to one or more embodiments of this aspect, the first parameter and second parameter are the parameters used to indicate the number of ROs in the frequency domain and the RB start index for the RO in the frequency domain, respectively, for the at least one UL-only symbol, and the wireless device is further configured to reposition at least one RO from outside a frequency bandwidth associated with an UL subband of the at least one SBFD symbol to inside the frequency bandwidth.

According to one or more embodiments of this aspect, the first and second parameters are received via one of radio resource control, RRC, signaling or system information, SI, signaling.

According to one or more embodiments of this aspect, the wireless device is further configured to map a plurality of SSBs to a plurality of valid ROs that meet the validity condition, where the plurality of valid ROs include all valid ROs within the plurality of UL-only symbols of the TDD configuration and all valid ROs within the plurality of SBFD symbols of the TDD configuration, where the mapping comprises mapping SSBs in order of increasing SSB index in a continuous manner to valid ROs in order of increasing frequency and then in increasing time.

According to one or more embodiments of this aspect, the wireless device is further configured to map a plurality of SSBs to a plurality of valid ROs that meet the validity condition, where the plurality of valid ROs includes all valid ROs within the plurality of UL-only symbols of the TDD configuration and all valid ROs within the plurality of SBFD symbols of the TDD configuration, where the mapping comprises: a first mapping is configured to map SSBs in order of increasing SSB index in a continuous manner to valid ROs within only the plurality of UL-only symbols in the TDD configuration in order of increasing frequency and then in increasing time, and a second mapping is configured to map SSBs in order of increasing SSB index in a continuous manner to valid ROs within only the plurality of SBFD symbols in the TDD configuration in order of increasing frequency and then in increasing time.

According to one or more embodiments of this aspect, the wireless device is further configured to receive an indication of a preamble received target power for at least one RO in the at least one SBFD symbol.

According to one or more embodiments of this aspect, the wireless device is further configured to receive an indication of an offset preamble received target power for at least one RO in the at least one SBFD symbol.

According to one or more embodiments of this aspect, the wireless device is further configured to transmit physical random access channel, PRACH, signaling in at least the RO.

According to another aspect of the present disclosure, a method implemented by a wireless device that is configured to communicate with a network node is provided. Frequency domain configuration information and time domain configuration information indicating a plurality of subband full duplex, SBFD, symbols and a plurality of uplink-, UL-, only symbols in a time division duplex, TDD, configuration is received. A validity of a random access channel, RACH, occasion, RO, is determined based on whether a validity condition is met, the RO being positioned in at least one SBFD symbol of the plurality of SBFD symbols or in at least one UL-only symbol of the plurality of UL-only symbols.

According to one or more embodiments of this aspect, the validity condition defines that the RO is valid based on the RO being positioned within the at least one SBFD symbol or within the at least one UL-only symbol.

According to one or more embodiments of this aspect, the validity condition indicates the RO is valid based on the RO being contained within a bandwidth of an UL subband of the at least one SBFD symbol.

According to one or more embodiments of this aspect, the validity condition indicates that the RO is valid based on all configured ROs in the at least one SBFD symbol being contained within a bandwidth of an UL subband of the at least one SBFD symbol.

According to one or more embodiments of this aspect, a first parameter indicating a number of ROs in the frequency domain within the at least one SBFD symbol is received.

According to one or more embodiments of this aspect, a second parameter, that indicates a resource block, RB, start index for the RO in the frequency domain within the at least one SBFD symbol is received.

According to one or more embodiments of this aspect, the first parameter is applicable to both the at least one SBFD symbol and the at least one UL-only symbol, and the second parameter is applicable only to the at least one SBFD symbol.

According to one or more embodiments of this aspect, the first parameter and second parameter are applicable only to the at least one SBFD symbol, and not the at least one UL-only symbol.

According to one or more embodiments of this aspect, the second parameter is an RB offset relative to the RB start index for the RO in the frequency domain within the at least one UL-only symbol.

According to one or more embodiments of this aspect, an RB offset relative to the RB start index for the RO in the frequency domain within the at least one UL-only symbol is determined.

According to one or more embodiments of this aspect, the second parameter is an RB offset relative to a starting RB of an UL subband within the at least one SBFD symbol.

According to one or more embodiments of this aspect, a starting RB during the at least one SBFD symbol is determined based at least one: a starting RB of a starting RO in the at least one UL-only symbol, and a starting RB of an UL subband in the at least one SBFD symbol.

According to one or more embodiments of this aspect, the first parameter and second parameter are the parameters used to indicate the number of ROs in the frequency domain and the RB start index for the RO in the frequency domain, respectively, for the at least one UL-only symbol, and where at least one RO is repositioned from outside a frequency bandwidth associated with an UL subband of the at least one SBFD symbol to inside the frequency bandwidth.

According to one or more embodiments of this aspect, the first and second parameters are received via one of radio resource control, RRC, signaling or system information signaling.

According to one or more embodiments of this aspect, a plurality of SSBs are mapped to a plurality of valid ROs that meet the validity condition, where the plurality of valid ROs including all valid ROs within the plurality of UL-only symbols of the TDD configuration and all valid ROs within the plurality of SBFD symbols of the TDD configuration, where the mapping comprising mapping SSBs in order of increasing SSB index in a continuous manner to valid ROs in order of increasing frequency and then in increasing time.

According to one or more embodiments of this aspect, a plurality of SSBs are mapped to a plurality of valid ROs that meet the validity condition, the plurality of valid ROs including all valid ROs within the plurality of UL-only symbols of the TDD configuration and all valid ROs within the plurality of SBFD symbols of the TDD configuration, where the mapping comprises: a first mapping configured to map SSBs in order of increasing SSB index in a continuous manner to valid ROs within the plurality of UL-only symbols in the TDD configuration in order of increasing frequency and then in increasing time, and a second mapping configured to map SSBs in order of increasing SSB index in a continuous manner to valid ROs within the plurality of SBFD symbols in the TDD configuration in order of increasing frequency and then in increasing time.

According to one or more embodiments of this aspect, an indication of a preamble received target power for at least one RO in the at least one SBFD symbol is received.

According to one or more embodiments of this aspect, an indication of an offset preamble received target power for at least one RO in the at least one SBFD symbol is received.

According to one or more embodiments of this aspect, physical random access channel, PRACH, signaling is transmitted in at least the RO.

According to another aspect of the present disclosure, a network node configured to communicate with a wireless device is provided. The network node is configured to transmit frequency domain configuration information and time domain configuration information indicating a plurality of subband full duplex, SBFD, symbols and a plurality of uplink-, UL-, only symbols in a time division duplex, TDD, configuration, and receive physical random access channel, PRACH, signaling in a random access channel occasion, RO that meets a validity condition, the RO being positioned in at least one SBFD symbol of the plurality of SBFD symbols or in at least one UL-only symbol of the plurality of UL-only symbols.

According to one or more embodiments of this aspect, the validity condition defines that the RO is valid based on the RO being positioned within the at least one SBFD symbol or within the at least one UL-only symbol.

According to one or more embodiments of this aspect, the validity condition indicates the RO is valid based on the RO being contained within a bandwidth of an UL subband of the at least one SBFD symbol.

According to one or more embodiments of this aspect, the validity condition indicates that the RO is valid based on all configured ROs in the at least one SBFD symbol being contained within a bandwidth of an UL subband of the at least one SBFD symbol.

According to one or more embodiments of this aspect, the network node is further configured to transmit a first parameter indicating a number of ROs in a frequency domain within the at least one SBFD symbol.

According to one or more embodiments of this aspect, the network node is further configured to transmit a second parameter, that indicates a resource block, RB, start index for the RO in the frequency domain within the at least one SBFD symbol.

According to one or more embodiments of this aspect, the first parameter is applicable to both the at least one SBFD symbol and the at least one UL-only symbol, and the second parameter is applicable only to the at least one SBFD symbol.

According to one or more embodiments of this aspect, the first parameter and second parameter are applicable only to the at least one SBFD symbol, and not the at least one UL-only symbol.

According to one or more embodiments of this aspect, the second parameter is an RB offset relative to the RB start index for the RO in the frequency domain within the at least one UL-only symbol.

According to one or more embodiments of this aspect, the second parameter is an RB offset relative to a starting RB of an UL subband within the at least one SBFD symbol.

According to one or more embodiments of this aspect, the first parameter and second parameter are the parameters used to indicate the number of ROs in the frequency domain and the RB start index for the RO in the frequency domain, respectively, for the at least one UL-only symbol, and where the network node is further configured to reposition at least one RO from outside a frequency bandwidth associated with an UL subband of the at least one SBFD symbol to inside the frequency bandwidth.

According to one or more embodiments of this aspect, the first and second parameters are received via one of radio resource control, RRC, signaling or system information, SI, signaling.

According to one or more embodiments of this aspect, the network node (16) is further configured to map a plurality of SSBs to a plurality of valid ROs that meet the validity condition, the plurality of valid ROs including all valid ROs within the plurality of UL-only symbols of the TDD configuration and all valid ROs within the plurality of SBFD symbols of the TDD configuration, the mapping comprising mapping SSBs in order of increasing SSB index in a continuous manner to valid ROs in order of increasing frequency and then in increasing time.

According to one or more embodiments of this aspect, the network node is further configured to map a plurality of SSBs to a plurality of valid ROs that meet the validity condition, the plurality of valid ROs including all valid ROs within the plurality of UL-only symbols of the TDD configuration and all valid ROs within the plurality of SBFD symbols of the TDD configuration, where the mapping comprises: a first mapping configured to map SSBs in order of increasing SSB index in a continuous manner to valid ROs within only the plurality of UL-only symbols in the TDD configuration in order of increasing frequency and then in increasing time; and a second mapping configured to map SSBs in order of increasing SSB index in a continuous manner to valid ROs within only the plurality of SBFD symbols in the TDD configuration in order of increasing frequency and then in increasing time.

According to one or more embodiments of this aspect, the network node is further configured to indicate a preamble received target power for at least one RO in the at least one SBFD symbol.

According to one or more embodiments of this aspect, the network node is further configured to indicate an offset preamble received target power for at least one RO in the at least one SBFD symbol.

According to one or more embodiments of this aspect, the network node is further configured to determine the validity of the RO based on whether the RO meets the validity condition.

According to another aspect of the present disclosure, a method implemented by a network node that is configured to communicate with a wireless device is provided. Frequency domain configuration information and time domain configuration information indicating a plurality of subband full duplex, SBFD, symbols and a plurality of uplink-, UL-, only symbols in a time division duplex, TDD, configuration is transmitted. Physical random access channel, PRACH, signaling is received in a random access channel occasion, RO that meets a validity condition, the RO being positioned in at least one SBFD symbol of the plurality of SBFD symbols or in at least one UL-only symbol of the plurality of UL-only symbols.

According to one or more embodiments of this aspect, the validity condition defines that the RO is valid based on the RO being positioned within the at least one SBFD symbol or within the at least one UL-only symbol.

According to one or more embodiments of this aspect, the validity condition indicates the RO is valid based on the RO being contained within a bandwidth of an UL subband of the at least one SBFD symbol.

According to one or more embodiments of this aspect, the validity condition indicates that the RO is valid based on all configured ROs in the at least one SBFD symbol being contained within a bandwidth of an UL subband of the at least one SBFD symbol.

According to one or more embodiments of this aspect, a first parameter indicating a number of ROs in the frequency domain within the at least one SBFD symbol is transmitted.

According to one or more embodiments of this aspect, a second parameter, that indicates a resource block, RB, start index for the RO in the frequency domain within the at least one SBFD symbol is transmitted.

According to one or more embodiments of this aspect, the first parameter is applicable to both the at least one SBFD symbol and the at least one UL-only symbol, and the second parameter is applicable only to the at least one SBFD symbol.

According to one or more embodiments of this aspect, the first parameter and second parameter are applicable only to the at least one SBFD symbol, and not the at least one UL-only symbol.

According to one or more embodiments of this aspect, the second parameter is an RB offset relative to the RB start index for the RO in the frequency domain within the at least one UL-only symbol.

According to one or more embodiments of this aspect, the second parameter is an RB offset relative to a starting RB of an UL subband within the at least one SBFD symbol. According to one or more embodiments of this aspect, the first parameter and second parameter are the parameters used to indicate the number of ROs in the frequency domain and the RB start index for the RO in the frequency domain, respectively, for the at least one UL-only symbol, and where at least one RO is repositioned from outside a frequency bandwidth associated with an UL subband of the at least one SBFD symbol to inside the frequency bandwidth.

According to one or more embodiments of this aspect, the first and second parameters are transmitted via system information signaling.

According to one or more embodiments of this aspect, a plurality of SSBs are mapped to a plurality of valid ROs that meet the validity condition, the plurality of valid ROs including all valid ROs within the plurality of UL-only symbols of the TDD configuration and all valid ROs within the plurality of SBFD symbols of the TDD configuration, where the mapping comprises mapping SSBs in order of increasing SSB index in a continuous manner to valid ROs in order of increasing frequency and then in increasing time.

According to one or more embodiments of this aspect, a plurality of SSBs are mapped to a plurality of valid ROs that meet the validity condition, the plurality of valid ROs including all valid ROs within the plurality of UL-only symbols of the TDD configuration and all valid ROs within the plurality of SBFD symbols of the TDD configuration, where the mapping comprises: a first mapping configured to map SSBs in order of increasing SSB index in a continuous manner to valid ROs within only the plurality of UL-only symbols in the TDD configuration in order of increasing frequency and then in increasing time, and a second mapping configured to map SSBs in order of increasing SSB index in a continuous manner to valid ROs within only the plurality of SBFD symbols in the TDD configuration in order of increasing frequency and then in increasing time.

According to one or more embodiments of this aspect, a preamble received target power for at least one RO in the at least one SBFD symbol is indicated.

According to one or more embodiments of this aspect, an offset preamble received target power for at least one RO in the at least one SBFD symbol is indicated.

According to one or more embodiments of this aspect, the validity of the RO is determined based on whether the RO meets the validity condition.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is an example of radio resources;

FIG. 2 is a slot;

FIG. 3 illustrates TDD and FDD;

FIG. 4 is an uplink/downlink structure for FDD and TDD;

FIG. 5 is an example TDD uplink/downlink (UL/DL) pattern;

FIG. 6 is another example of an UL/DL pattern;

FIG. 7 illustrates conventional TDD carriers;

FIG. 8 illustrates a subband full duplex system;

FIG. 9 is an example of 3 resource block (RB) sets;

FIG. 10 is another example of 3 RB sets;

FIG. 11 is an example of a TDD antenna array;

FIG. 12 is an example antenna architecture;

FIG. 13 is an example PRACH configuration;

FIG. 14 is an example mapping;

FIG. 15 is a schematic diagram of an example network architecture illustrating a communication system connected via an intermediate network to a host computer according to the principles in the present disclosure;

FIG. 16 is a block diagram of a host computer communicating via a network node with a wireless device over an at least partially wireless connection according to some embodiments of the present disclosure;

FIG. 17 is a flowchart illustrating example methods implemented in a communication system including a host computer, a network node and a wireless device for executing a client application at a wireless device according to some embodiments of the present disclosure;

FIG. 18 is a flowchart illustrating example methods implemented in a communication system including a host computer, a network node and a wireless device for receiving user data at a wireless device according to some embodiments of the present disclosure;

FIG. 19 is a flowchart illustrating example methods implemented in a communication system including a host computer, a network node and a wireless device for receiving user data from the wireless device at a host computer according to some embodiments of the present disclosure;

FIG. 20 is a flowchart illustrating example methods implemented in a communication system including a host computer, a network node and a wireless device for receiving user data at a host computer according to some embodiments of the present disclosure;

FIG. 21 is a flowchart of an example process in a network node for a physical random access channel for subband full duplex operation;

FIG. 22 is a flowchart of an example process in a WD for a physical random access channel for subband full duplex operation;

FIG. 23 is a flowchart of another example process in a network node for a physical random access channel for subband full duplex operation;

FIG. 24 is a flowchart of another example process in a WD for a physical random access channel for subband full duplex operation;

FIG. 25 shows available RBs for UL transmission;

FIG. 26 shows valid RACH occasions in both subband frequency domain (SBFD) and UL-only symbols;

FIG. 27 is one example of RO validation;

FIG. 28 is one example of separate frequency domain PRACH configuration in the UL-only and SBFD symbols;

FIG. 29 is one example of separate SSB-to-RO mapping; and

FIG. 30 is another example of SSB-to-RO mapping.

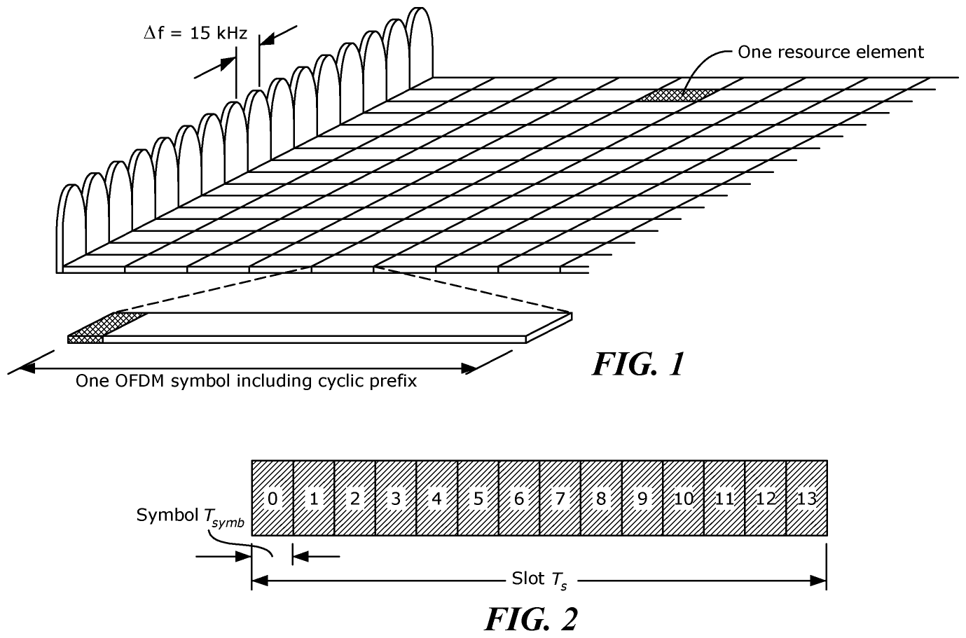

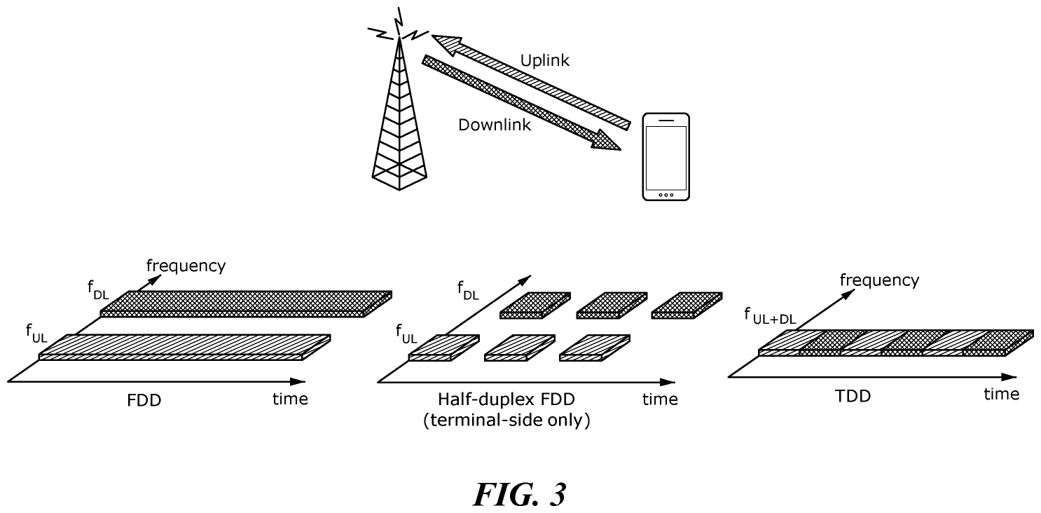

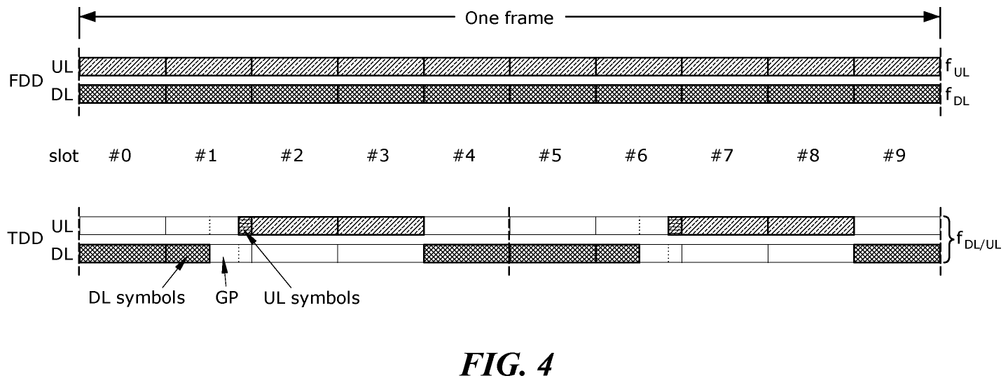

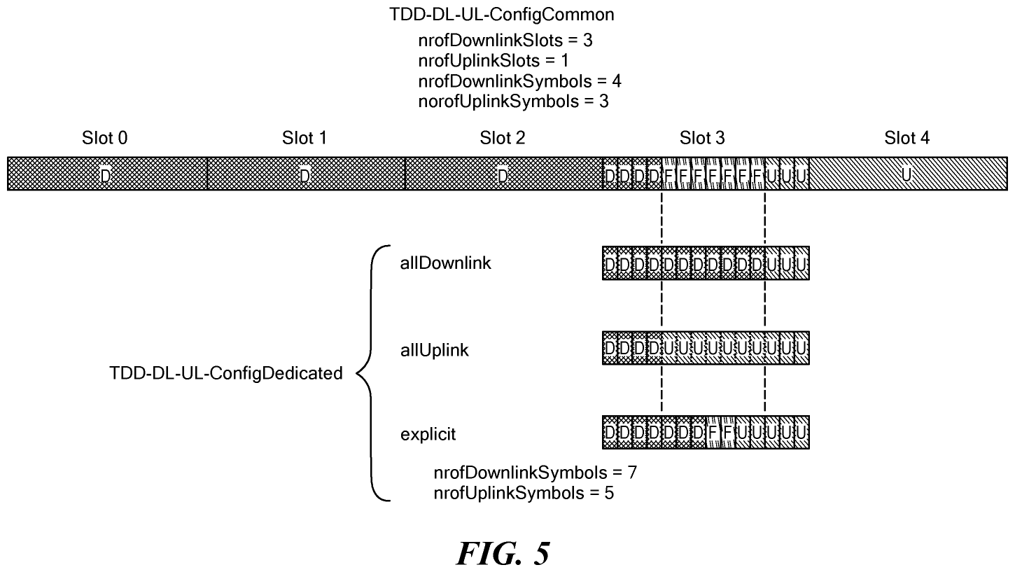

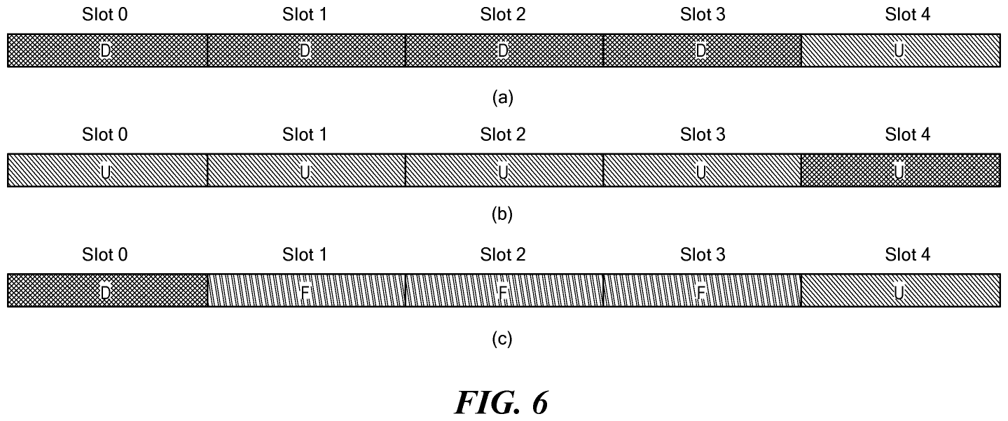

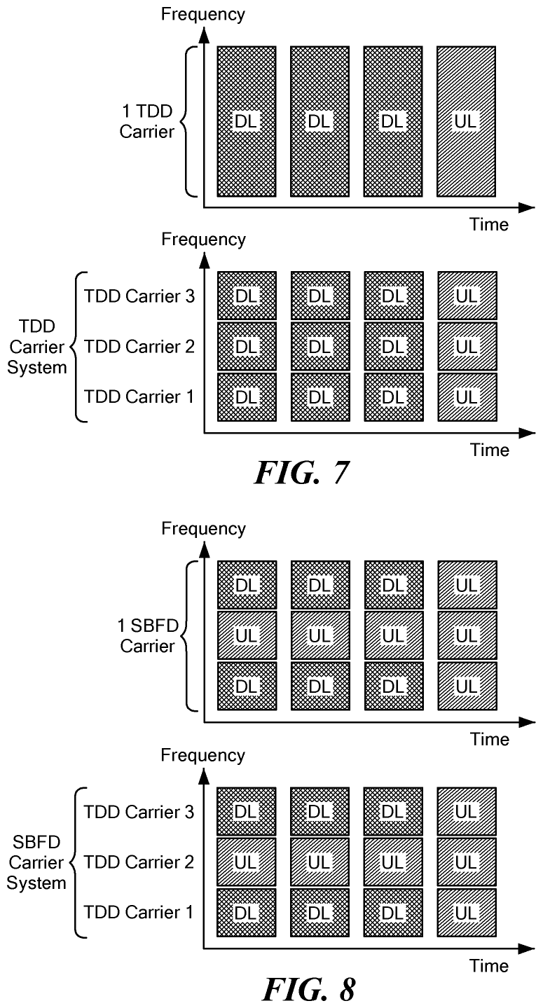

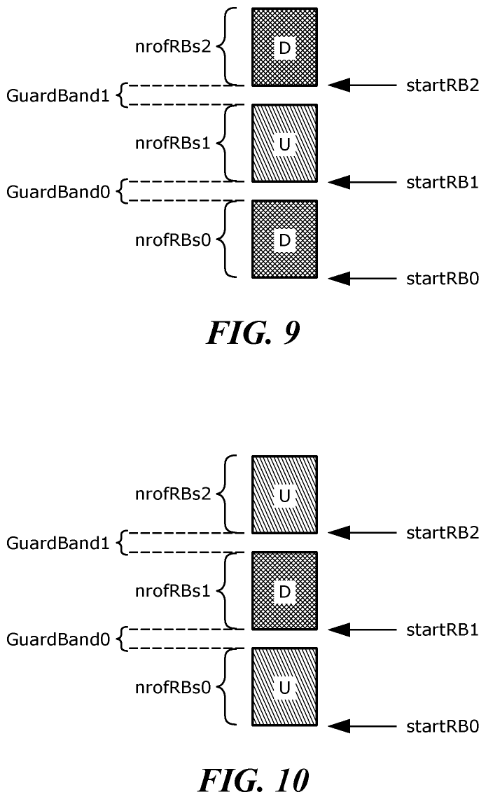

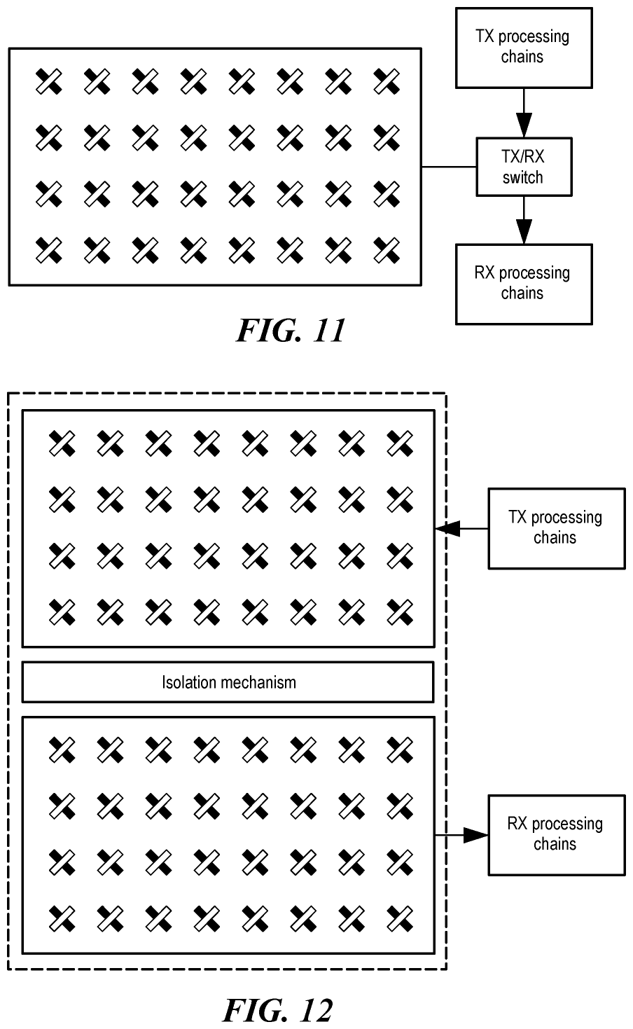

### DETAILED DESCRIPTION

Before describing in detail example embodiments, it is noted that the embodiments reside primarily in combinations of apparatus components and processing steps related to a physical random access channel for subband full duplex operation. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein may be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide a physical random access channel for subband full duplex operation.

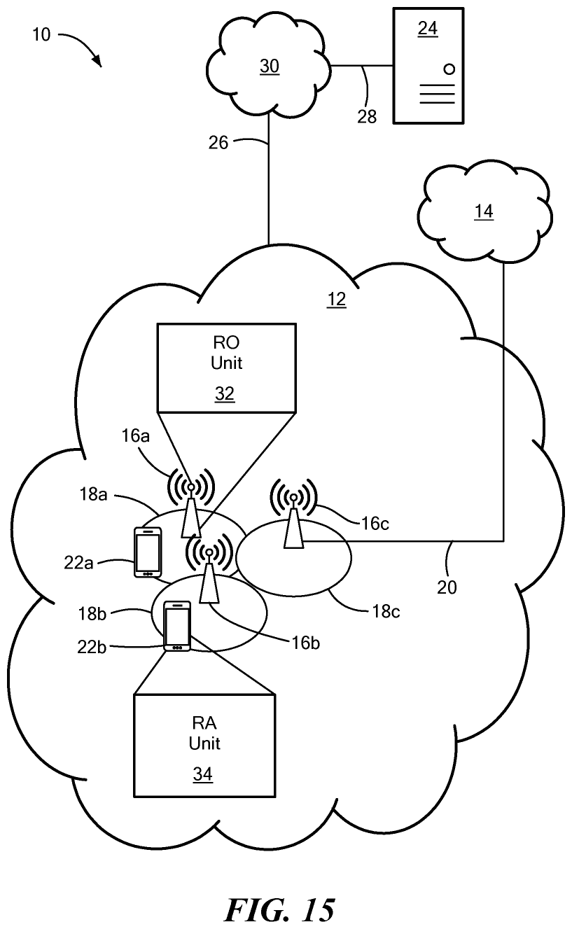

Returning now to the drawing figures, in which like elements are referred to by like reference numerals, there is shown in FIG. 15 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 may be in simultaneous communication and/or configured to separately communicate with more than one network node 16 and more than one type of network node 16. For example, a WD 22 may have dual connectivity with a network node 16 that supports LTE and the same or a different network node 16 that supports NR. As an example, WD 22 may be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 15 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include an RO unit 32 which is configured to determine a validity of a random access channel, RACH, occasion, RO, based at least in part on whether the RO occasion is contained within an uplink, UL, subband. A wireless device 22 is configured to include an RA unit 34 which is configured to perform random access in first subband frequency domain, SBFD, symbols and uplink (UL)-only symbols.

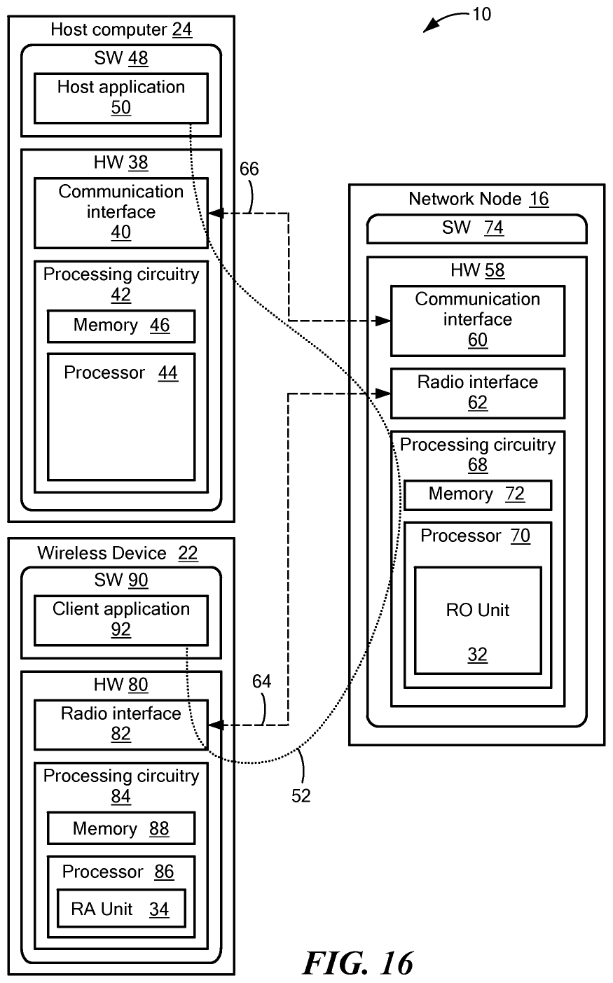

Example implementations, in accordance with an embodiment, of the WD 22, network node 16 and host computer 24 discussed in the preceding paragraphs will now be described with reference to FIG. 16. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include an RO unit 32 which is configured to determine a validity of a random access channel, RACH, occasion, RO, based at least in part on whether the RO occasion is contained within an uplink, UL, subband.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. In particular, the processing circuitry 84 may include an RA unit 34 which is configured to perform random access in first subband frequency domain, SBFD, symbols and uplink (UL)-only symbols.

In some embodiments, the inner workings of the network node 16, WD 22, and host computer 24 may be as shown in FIG. 16 and independently, the surrounding network topology may be that of FIG. 15.

In FIG. 16, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 15 and 16 show various “units” such as RO unit 32 and RA unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

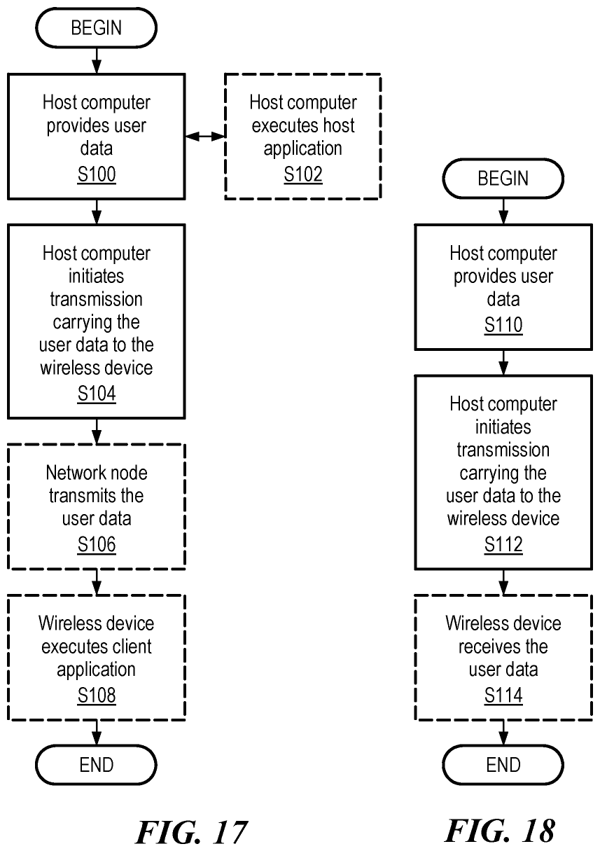

FIG. 17 is a flowchart illustrating an example method implemented in a communication system, such as, for example, the communication system of FIGS. 15 and 16, in accordance with one embodiment. The communication system may include a host computer 24, a network node 16 and a WD 22, which may be those described with reference to FIG. 16. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 18 is a flowchart illustrating an example method implemented in a communication system, such as, for example, the communication system of FIG. 15, in accordance with one embodiment. The communication system may include a host computer 24, a network node 16 and a WD 22, which may be those described with reference to FIGS. 15 and 16. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

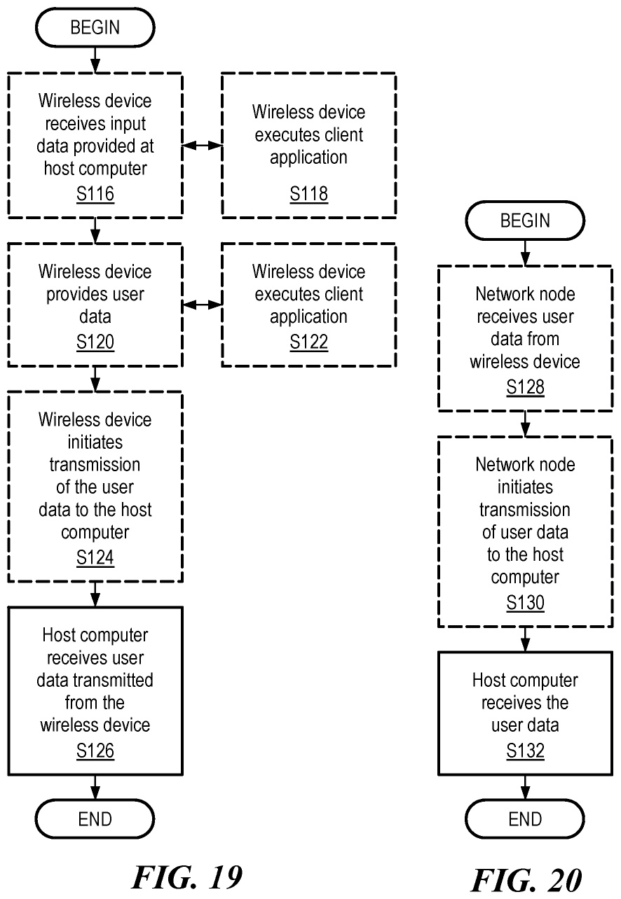

FIG. 19 is a flowchart illustrating an example method implemented in a communication system, such as, for example, the communication system of FIG. 15, in accordance with one embodiment. The communication system may include a host computer 24, a network node 16 and a WD 22, which may be those described with reference to FIGS. 15 and 16. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 20 is a flowchart illustrating an example method implemented in a communication system, such as, for example, the communication system of FIG. 15, in accordance with one embodiment. The communication system may include a host computer 24, a network node 16 and a WD 22, which may be those described with reference to FIGS. 15 and 16. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

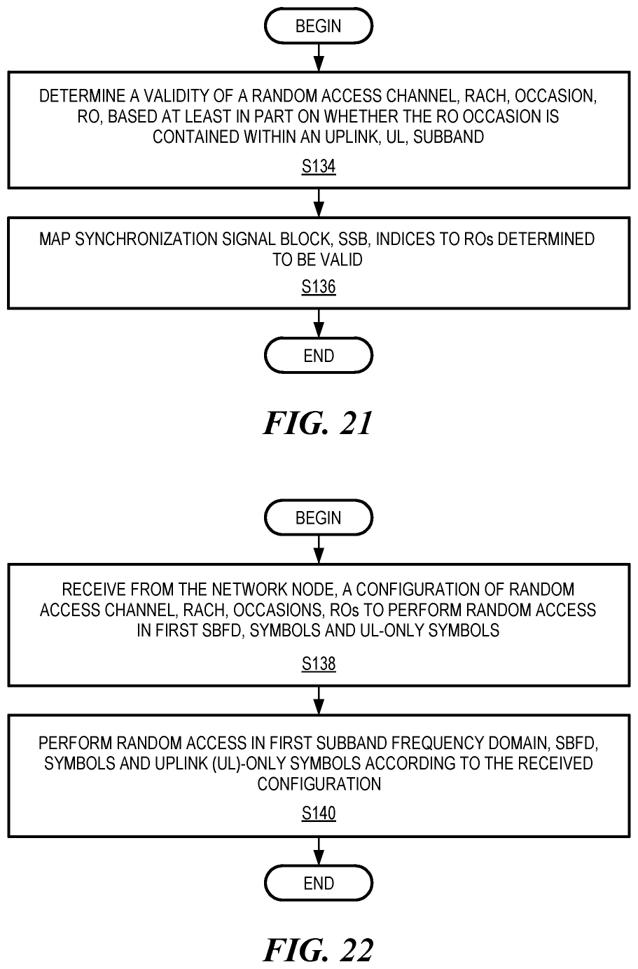

FIG. 21 is a flowchart of an example process in a network node 16 for a physical random access channel for subband full duplex operation. One or more blocks described herein may be performed by one or more elements of network node 16 such as by one or more of processing circuitry 68 (including the RO unit 32), processor 70, radio interface 62 and/or communication interface 60. Network node 16 such as via processing circuitry 68 and/or processor 70 and/or radio interface 62 and/or communication interface 60 is configured to determine a validity of a random access channel, RACH, occasion, RO, based at least in part on whether the RO occasion is contained within an uplink, UL, subband (Block S134). The process also includes mapping synchronization signal block, SSB, indices to ROs determined to be valid (Block S136).

In some embodiments, the mapping includes mapping in a frequency-first/time-second manner over all ROs, regardless of symbol type. In some embodiments, the mapping includes mapping to a subband frequency domain, SBFD, symbols and UL-only symbols. In some embodiments, the method includes configuring the WD 22 to perform random access in first subband frequency domain, SBFD, symbols and UL-only symbols. In some embodiments, determining the validity of an RO includes determining whether the RO is within one of subband frequency domain, SBFD, symbols and UL-only symbols.

FIG. 22 is a flowchart of an example process in a wireless device 22 according to some embodiments of the present disclosure. One or more blocks described herein may be performed by one or more elements of wireless device 22 such as by one or more of processing circuitry 84 (including the RA unit 34), processor 86, and/or radio interface 82. Wireless device 22 such as via processing circuitry 84 and/or processor 86 and/or radio interface 83 is configured to receive from the network node, a configuration of random access channel, RACH, occasions, ROs (Block S136). The process also includes performing random access in first subband frequency domain, SBFD, symbols and uplink (UL)-only symbols (Block S138). In some embodiments, the method also includes determining a resource block, RB, offset base at least in part on a size of a subband associated with the SBFD symbols and the UL-only symbols.

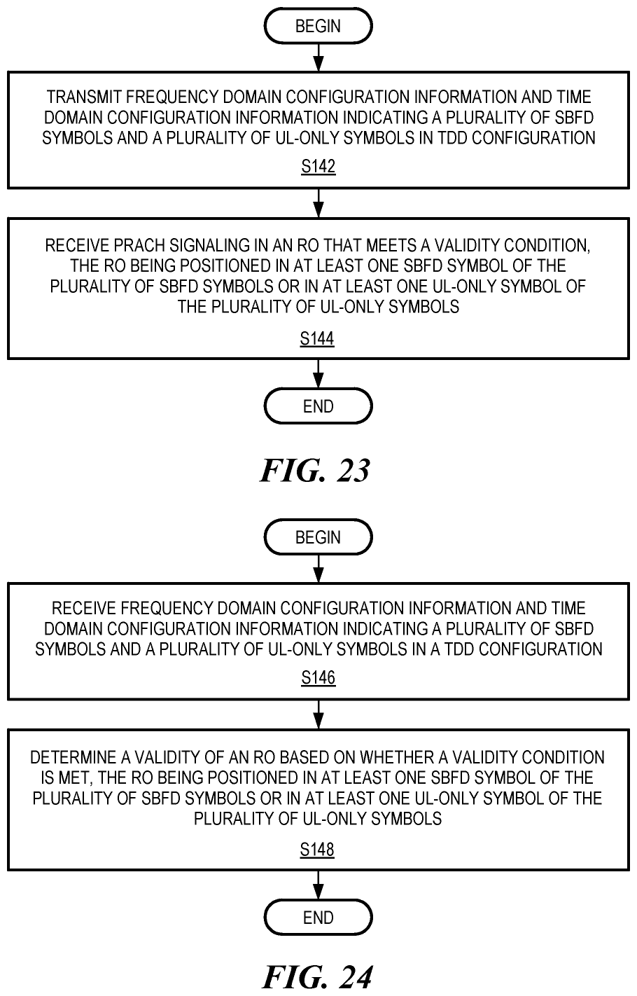

FIG. 23 is a flowchart of another example process in a network node 16 for a physical random access channel for subband full duplex operation. One or more blocks described herein may be performed by one or more elements of network node 16 such as by one or more of processing circuitry 68 (including the RO unit 32), processor 70, radio interface 62 and/or communication interface 60.

Network node 16 is configured to transmit (Block S142) frequency domain configuration information and time domain configuration information indicating a plurality of subband full duplex, SBFD, symbols and a plurality of uplink-, UL-, only symbols in a time division duplex, TDD, configuration, as described herein. Network node 16 is configured to receive (Block S144) physical random access channel, PRACH, signaling in a random access channel occasion, RO that meets a validity condition, where the RO is positioned in at least one SBFD symbol of the plurality of SBFD symbols or in at least one UL-only symbol of the plurality of UL-only symbols, as described herein. In one or more embodiments, the validity condition is a time and/or frequency domain condition usable for determining whether one or more ROs are valid.

According to one or more embodiments, the validity condition defines that the RO is valid based on the RO being positioned within the at least one SBFD symbol or within the at least one UL-only symbol.

According to one or more embodiments, the validity condition indicates the RO is valid based on the RO being contained within a bandwidth of an UL subband of the at least one SBFD symbol.

According to one or more embodiments, the validity condition indicates that the RO is valid based on all configured ROs in the at least one SBFD symbol being contained within a bandwidth of an UL subband of the at least one SBFD symbol.

According to one or more embodiments, the network node 16 is further configured to transmit a first parameter indicating a number of ROs in a frequency domain within the at least one SBFD symbol.

According to one or more embodiments, the network node 16 is further configured to transmit a second parameter, that indicates a resource block, RB, start index for the RO in the frequency domain within the at least one SBFD symbol.

According to one or more embodiments, the first parameter is applicable to both the at least one SBFD symbol and the at least one UL-only symbol, and the second parameter is applicable only to the at least one SBFD symbol.

According to one or more embodiments, the first parameter and second parameter are applicable only to the at least one SBFD symbol, and not the at least one UL-only symbol.

According to one or more embodiments, the second parameter is an RB offset relative to the RB start index for the RO in the frequency domain within the at least one UL-only symbol.

According to one or more embodiments, the second parameter is an RB offset relative to a starting RB of an UL subband within the at least one SBFD symbol.

According to one or more embodiments, the first parameter and second parameter are the parameters used to indicate the number of ROs in the frequency domain and the RB start index for the RO in the frequency domain, respectively, for the at least one UL-only symbol, and where the network node 16 is further configured to reposition at least one RO from outside a frequency bandwidth associated with an UL subband of the at least one SBFD symbol to inside the frequency bandwidth.

According to one or more embodiments, the first and second parameters are received via one of radio resource control, RRC, signaling or system information, SI, signaling.

According to one or more embodiments, the network node 16 is further configured to map a plurality of SSBs to a plurality of valid ROs that meet the validity condition, where the plurality of valid ROs including all valid ROs within the plurality of UL-only symbols of the TDD configuration and all valid ROs within the plurality of SBFD symbols of the TDD configuration, the mapping comprising mapping SSBs in order of increasing SSB index in a continuous manner to valid ROs in order of increasing frequency and then in increasing time.

According to one or more embodiments, the network node 16 is further configured to map a plurality of SSBs to a plurality of valid ROs that meet the validity condition, where the plurality of valid ROs including all valid ROs within the plurality of UL-only symbols of the TDD configuration and all valid ROs within the plurality of SBFD symbols of the TDD configuration, where the mapping comprises: a first mapping configured to map SSBs in order of increasing SSB index in a continuous manner to valid ROs within only the plurality of UL-only symbols in the TDD configuration in order of increasing frequency and then in increasing time, and a second mapping configured to map SSBs in order of increasing SSB index in a continuous manner to valid ROs within only the plurality of SBFD symbols in the TDD configuration in order of increasing frequency and then in increasing time.

According to one or more embodiments, the network node 16 is further configured to indicate a preamble received target power for at least one RO in the at least one SBFD symbol.

According to one or more embodiments, the network node 16 is further configured to indicate an offset preamble received target power for at least one RO in the at least one SBFD symbol.

According to one or more embodiments, the network node 16 is further configured to determine the validity of the RO based on whether the RO meets the validity condition.

FIG. 24 is a flowchart of an example process in a wireless device 22 according to some embodiments of the present disclosure. One or more blocks described herein may be performed by one or more elements of wireless device 22 such as by one or more of processing circuitry 84 (including the RA unit 34), processor 86, and/or radio interface 82.

Wireless device 22 is configured to receive (Block S146) frequency domain configuration information and time domain configuration information indicating a plurality of subband full duplex, SBFD, symbols and a plurality of uplink-, UL-, only symbols in a time division duplex, TDD, configuration, as described herein. Wireless device 22 is configured to determine (Block S148) a validity of a random access channel, RACH, occasion, RO, based on whether a validity condition is met, where the RO is positioned in at least one SBFD symbol of the plurality of SBFD symbols or in at least one UL-only symbol of the plurality of UL-only symbols, as described herein.

According to one or more embodiments, the validity condition defines that the RO is valid based on the RO being positioned within the at least one SBFD symbol or within the at least one UL-only symbol.

According to one or more embodiments, the validity condition indicates the RO is valid based on the RO being contained within a bandwidth of an UL subband of the at least one SBFD symbol.

According to one or more embodiments, the validity condition indicates that the RO is valid based on all configured ROs in the at least one SBFD symbol being contained within a bandwidth of an UL subband of the at least one SBFD symbol.

According to one or more embodiments, the wireless device 22 is further configured to receive a first parameter indicating a number of ROs in the frequency domain within the at least one SBFD symbol.

According to one or more embodiments, the wireless device 22 is further configured to receive a second parameter, that indicates a resource block, RB, start index for the RO in the frequency domain within the at least one SBFD symbol.

According to one or more embodiments, the first parameter is applicable to both the at least one SBFD symbol and the at least one UL-only symbol, and the second parameter is applicable only to the at least one SBFD symbol.

According to one or more embodiments, the first parameter and second parameter are applicable only to the at least one SBFD symbol, and not the at least one UL-only symbol.

According to one or more embodiments, the second parameter is an RB offset relative to the RB start index for the RO in the frequency domain within the at least one UL-only symbol.

According to one or more embodiments, the wireless device 22 is further configured to determine an RB offset relative to the RB start index for the RO in the frequency domain within the at least one UL-only symbol.

According to one or more embodiments, the second parameter is an RB offset relative to a starting RB of an UL subband within the at least one SBFD symbol.

According to one or more embodiments, the wireless device 22 is further configured to determine a starting RB during the at least one SBFD symbol based at least one: a starting RB of a starting RO in the at least one UL-only symbol, and a starting RB of an UL subband in the at least one SBFD symbol.

According to one or more embodiments, the first parameter and second parameter are the parameters used to indicate the number of ROs in the frequency domain and the RB start index for the RO in the frequency domain, respectively, for the at least one UL-only symbol, and the wireless device 22 is further configured to reposition at least one RO from outside a frequency bandwidth associated with an UL subband of the at least one SBFD symbol to inside the frequency bandwidth.

According to one or more embodiments, the first and second parameters are received via one of radio resource control, RRC, signaling or system information, SI, signaling.

According to one or more embodiments, the wireless device 22 is further configured to map a plurality of SSBs to a plurality of valid ROs that meet the validity condition, where the plurality of valid ROs including all valid ROs within the plurality of UL-only symbols of the TDD configuration and all valid ROs within the plurality of SBFD symbols of the TDD configuration, the mapping comprising mapping SSBs in order of increasing SSB index in a continuous manner to valid ROs in order of increasing frequency and then in increasing time.

According to one or more embodiments, the wireless device 22 is further configured to map a plurality of SSBs to a plurality of valid ROs that meet the validity condition, where the plurality of valid ROs including all valid ROs within the plurality of UL-only symbols of the TDD configuration and all valid ROs within the plurality of SBFD symbols of the TDD configuration, where the mapping comprises: a first mapping configured to map SSBs in order of increasing SSB index in a continuous manner to valid ROs within only the plurality of UL-only symbols in the TDD configuration in order of increasing frequency and then in increasing time, and a second mapping configured to map SSBs in order of increasing SSB index in a continuous manner to valid ROs within only the plurality of SBFD symbols in the TDD configuration in order of increasing frequency and then in increasing time.

According to one or more embodiments, the wireless device 22 is further configured to receive an indication of a preamble received target power for at least one RO in the at least one SBFD symbol.

According to one or more embodiments, the wireless device 22 is further configured to receive an indication of an offset preamble received target power for at least one RO in the at least one SBFD symbol.

According to one or more embodiments, the wireless device 22 is further configured to transmit physical random access channel, PRACH, signaling in at least the RO.

Having described the general process flow of arrangements of the disclosure and having provided examples of hardware and software arrangements for implementing the processes and functions of the disclosure, the sections below provide details and examples of arrangements for a physical random access channel for subband full duplex operation.

In the following embodiments, an SBFD symbol is a symbol that is configured such that it may be used for SBFD operation, i.e., simultaneous gNB transmission/reception within the same carrier. In one example, an SBFD symbol contains two ‘D’ frequency subbands (RB sets) and one ‘U’ subband (RB set) in the middle of the carrier—a so-called D-U-D configuration. In contrast, an UL-only symbol is a symbol which may only be used for WD transmission within the carrier.

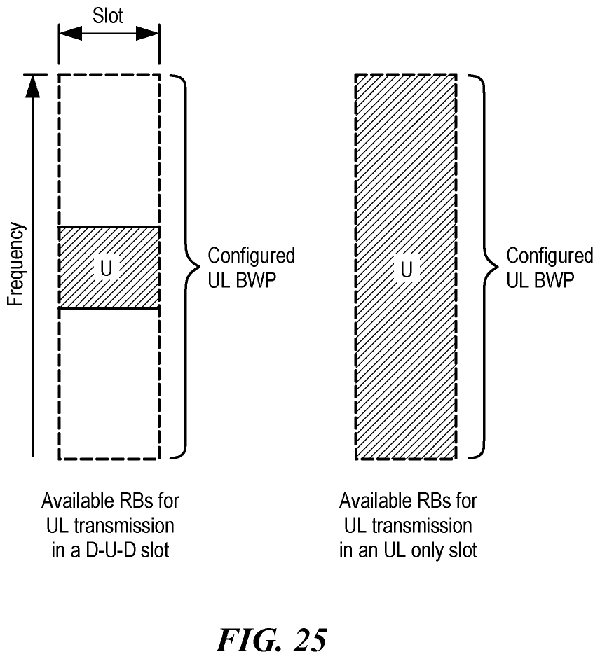

Some embodiments include methods to enable WDs to perform RACH in a ‘U’ subband of these symbols instead of only in the UL-only symbols. In some embodiments, the number of RBs available for RACH is different in the SBFD symbols compared to the UL-only symbols. This is illustrated in FIG. 25.

A non-limiting example system configuration is as follows:

$$The UL BWP size {N}_{BWP}^{size} = 273 RBs ;$$

$$The UL subband size {N}_{ULsubband}^{size} = 51 RBs ;$$

$$The first UL subband RB index within the BWP is {RB}_{start}^{ULsubband} = 111 ;$$

$$and / or$$

$$The last UL subband RB index within the BWP is {RB}_{end}^{ULsubband} = {RB}_{s t a r t}^{U L s ubband} + {N}_{U L s ubband}^{s i z e} - 1 = 161 .$$

### Group a Embodiments (Based on Overlapping FDRA)

### Embodiment #A-1

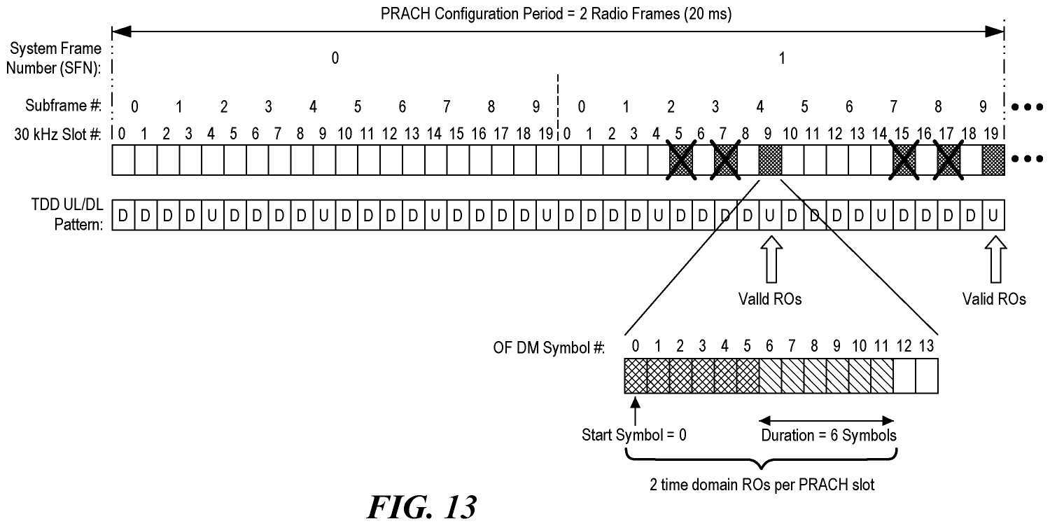

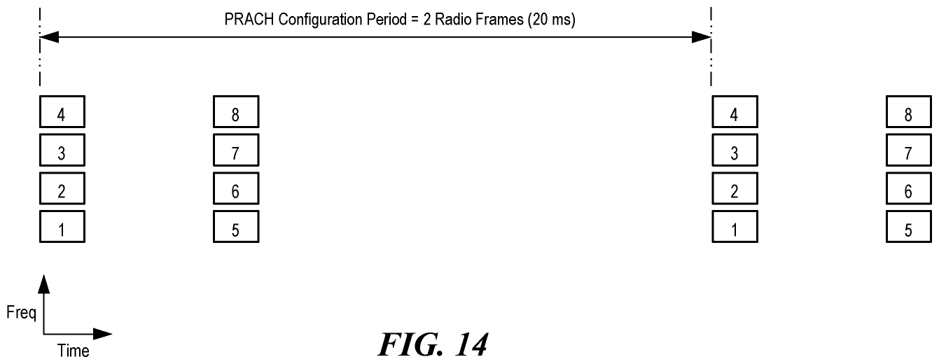

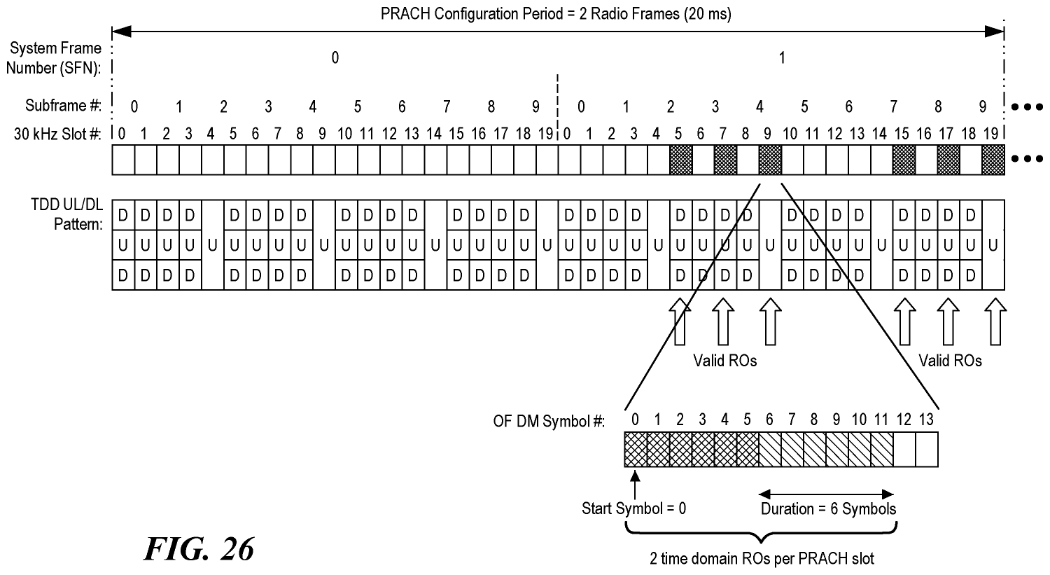

This embodiment is exemplified using the same PRACH configuration as in FIG. 13, except that all symbols of the ‘D’ slots in the TDD UL/DL pattern are now configured for SBFD operation using a D-U-D subband configuration. In this embodiment, ROs are valid in both SBFD and UL-only symbols. This is illustrated in FIG. 26 where it is shown that ROs in slots in 5, 7, 9, 15, 17, and 19 are valid compared to only slots 9 and 19 in FIG. 13.

Some embodiments may include one or more of the following aspects:
The PRACH configuration index is selected from an existing table in current 3GPP Specifications' (e.g., index 118 as shown in FIG. 13 and FIG. 26);
msg1-FDM and msg1-FrequencyStart are configured such that all FDM'd ROs are fully contained within the active BWP within UL-only symbols, disregarding the fact that some ROs in the SBFD symbols may not be fully contained within the ‘U’ subband of these symbols; and/or
Validation of ROs includes a new time and frequency domain condition. This is in addition to the time domain condition that exists in current 3GPP Technical Specifications and Releases’. In some embodiments, this joint time and frequency domain condition may begiven as follows:
   A PRACH occasion in a PRACH slot is valid if:
      it is within UL symbols (as in ‘3GPP TS 38.213); and/or
      it is within SBFD symbols, and the RBs of the PRACH occasion are fully contained within the ‘U’ subband;
   Otherwise, a PRACH occasion in invalid.

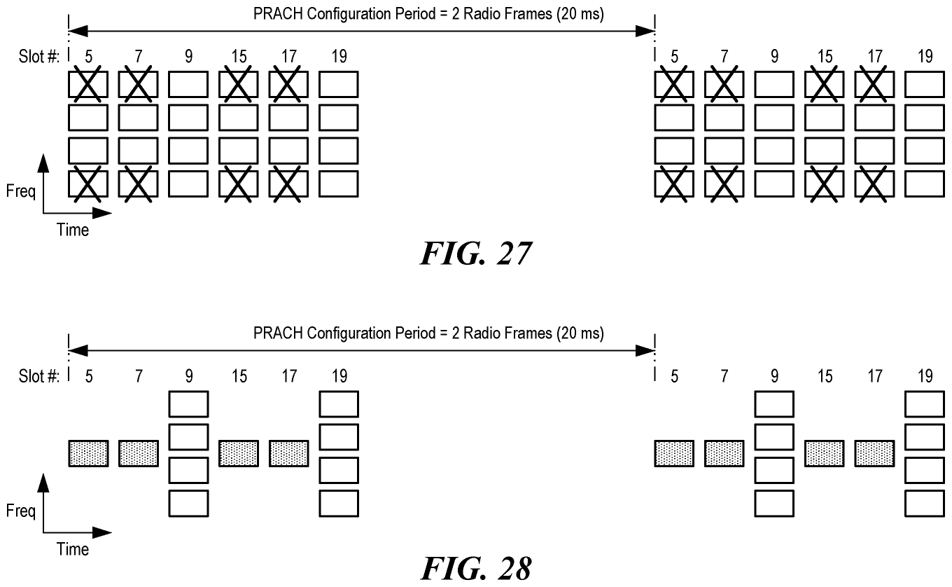

FIG. 27 is an example where 4 FDM'd ROs are configured. In the UL-only symbols (slots 9 and 19), all 4 ROs are valid by necessity; otherwise, it is a misconfiguration. In this example, it is assumed that the ‘U’ subband in the SBFD symbols in slots 5, 7, 15, 17 is wide enough to fully contain the middle two ROs in the frequency domain. Using the above validation rule, the edge ROs in the SBFD symbols of these slots are invalidated, leaving only the two middle ROs.

### Embodiment #A-2

This embodiment inherits the procedures of Embodiment #A-1, except that for any RO to be valid, the configured ROs must all be fully contained within the bandwidth of the UL-subband, regardless of whether the RO is in UL-only or SBFD symbols

### Group B Embodiments (Based on Slot-Dependent FDRA Interpretation)

In some embodiments, a slot dependent configuration of RO occasions is disclosed, where one slot type consists of UL-only symbols, and another slot-type consists of SBFD symbols. The following aspects are common to all Group B embodiments:
PRACH configuration index is selected according to current NR specs and protocols (e.g., index 118 as discussed above);
FDM'd ROs in UL-only symbols are configured according to current NR specs and protocols based on existing RRC parameters msg1-FDMand msg1-FrequencyStart;
Validation of ROs includes at least a new time domain condition. This is in addition to the time domain condition that exists in current 3GPP Specifications'. The joint condition is given as follows:
   A PRACH occasion in a PRACH slot is valid if:
      it is within UL symbols (as in ‘3GPP TS 38.213); and/or
      is within SBFD symbols; and/or
   Otherwise, a PRACH occasion is invalid.

### Embodiment #B-1 (Explicit Parameter for RB Start Index)

This embodiments includes the following aspects applicable to ROs in SBFD symbols:
A new RRC parameter is defined to indicate the RB start index for the first RO in the frequency domain in SBFD symbols, e.g., msg1-FrequencyStart2 where the RB index is contained within the ‘U’ subband; and/or
The WD determines a number of ROs in the frequency domain in SBFD symbols, according to the existing RRC parameter msg1-FDM.

In one or more embodiments, new RRC parameter may refer to a non-legacy parameter or RRC parameters that are separate compared to the parameters defined for the at least one UL-symbol.

In a variation of this embodiment, if the UL subband size is small enough such that one or more of the configured ROs in the frequency domain fall outside the UL subband, those ROs are invalidated using the same RO validation procedure as in Embodiment #A-1 that includes both a new time and frequency domain condition.

### Embodiment #B-2 (Explicit Parameters for RB Start Index and Number of FDM'd ROs)

This embodiment includes the following aspects for ROs in SBFD symbols:
A first new RRC parameter is defined to indicate the RB start index for the first RO in the frequency domain in SBFD symbols, e.g., msg1-FrequencyStart2 where the RB index is contained within the ‘U’ subband in SBFD symbols; and/or
A second new RRC parameter is defined to indicate the number of FDM'd ROs in the frequency domain in SBFD symbols, e.g., msg1-FDM2;

FIG. 28 shows an example where 4 FDM'd ROs are configured in the UL-only symbols (slots 9 and 19) using parameters msg1-FDMand msg1-FrequencyStart. In SBFD symbols (slots 5, 7, 15, 17) separate parameters msg1-FDM2 and msg1-FrequencyStart2 are used to configure only a single FDM'd RO in the ‘U’ subband. All PRACH slots in the time domain contain valid ROs since all symbols in the TDD UL/DL pattern are either SBFD or UL-only symbols.

This embodiment inherits the procedures of either Embodiment #B-1 or #B-2, except the RB start index for the 1st RO in SBFD symbols is determined instead based on an RB offset

$$R {B}_{offset}^{U L s ubband}$$

relative to the existing RB start index msg1-FrequencyStart configured by RRC:

$$R {B}_{start}^{1 stRO} = msg 1 - FrequencyStart + {RB}_{offset}^{U L s ubband}$$

In some embodiments, the offset

$$R {B}_{offset}^{ULsubband}$$

is semi-statically configured to the WD from the network, via RRC configuration or via system information transmissions.

In some embodiments, instead of explicit signaling of the offset(s) to the WD, the WD determines the offset implicitly as a function of the bandwidth part size

$${N}_{BWP}^{size} ,$$

UL subband size

$${N}_{U L s ubband}^{size} ,$$

DL subband size(s), the existing starting RB index msg1-FrequencyStart, or any combination of these values.

### Embodiment #B-4 (RB Offset Relative to First RB of the UL Subband)

This embodiment inherits the procedures of either Embodiment #B-1 or #B-2, except the RB start index for the 1^{st} RO in SBFD symbols is determined instead based on an RB offset

$${RB}_{offset}^{ULsubband}$$

relative to the first RB of the UL subband:

$$R {B}_{start}^{1 stRO} = R {B}_{start}^{U L s ubband} + R {B}_{offset}^{U L s ubband}$$

In some embodiments, the offset

$$R {B}_{offset}^{ULsubband}$$

is semi-statically configured to the WD from the network, via RRC configuration or via system information transmissions. In another non-limiting example, the offset

$$R {B}_{offset}^{U L s ubband}$$

is not explicitly signaled, but is stated in specifications.

### Embodiment #B-5 (Starting RB Relative to First RB of the UL Subband)

This embodiment inherits the procedures of either Embodiment #B-1 or #B-2, except the RB start index for the 1^{st} RO in SBFD symbols is determined instead relative to the first RB of the UL subband based on the existing RRC parameter msg1-FrequencyStart:

$$R {B}_{s t a r t}^{1 s t R O} = R {B}_{s t a r t}^{U L s ubband} + msg 1 - FrequencyStart$$

### Embodiment #B-6 (Starting RB Relative to the First RB of the UL Subband+Modulo Wrapping)

This embodiments includes one or more of the following aspects applicable to ROs in SBFD symbols:
The RB start index for the 1^{st} RO in SBFD symbols is determined relative to the first RB of the UL subband based on the existing RRC parameter msg1-FrequencyStart:

$$R {B}_{s t a r t}^{1 s t R O} = R {B}_{s t a r t}^{U L s ubband} + msg 1 - FrequencyStart ;$$

The WD determines a number of ROs in the frequency domain in SBFD symbols, according to the existing RRC parameter msg1-FDM; and/or
If the UL subband size is small enough such that one or more of the configured ROs in the frequency domain fall outside the UL subband, the RB start index for one or more of those ROs is wrapped back into the UL subband using a modulo operation. For the n-th RO, the starting RB index is thus adjusted as follows:

$$R {B}_{s t a r t}^{n - t h R O} = R {B}_{s t a r t}^{U L s ubband} + R {B}_{n} m o d {N}_{U L s ubband}^{size}$$

where RBₙ is the starting RB index of the n-th RO prior to adjustment.

### Group C Embodiments (SSB-to RO Mapping)

Any of the Group A or Group B embodiments may be used for determining the valid ROs in both the time and frequency domains. After the valid ROs are determined, SSB indices must be mapped to the valid ROs. The legacy approach for this mapping was discussed above with reference to FIG. 25 for static TDD systems. Various embodiments are disclosed herein for mapping of SSB indices to ROs for the case of an SBFD system.

### Embodiment #C-1 (Continuous SSB-to-RO Mapping Over all ROs)

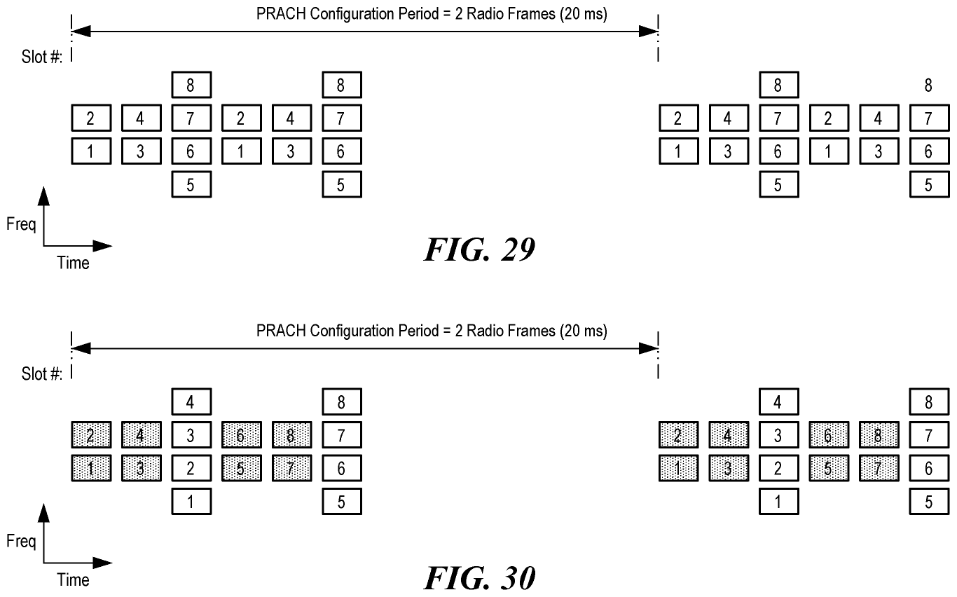

FIG. 29 shows an example set of valid ROs determined using any of the Group A or B embodiments in which 2 frequency domain ROs are valid in each of the slots for which SBFD symbols are configured, and in which 4 frequency domain ROs are valid in each of the UL-only slots.

In this embodiment, SSB indices are mapped frequency first and time second in a continuous fashion over all valid ROs disregarding that SBFD and UL-only symbols have different number of ROs in the frequency domain. FIG. 27 shows the SSB indices that are mapped to each RO for the example where ssb-perRACH-OccasionAndCB-PreamblesPerSSB is configured as ‘one,’ i.e., only one SSB index mapped to each RO.

FIG. 30 shows an example set of valid ROs determined using any of the Group A or B embodiments in which 2 frequency domain ROs are valid in each of the slots for which SBFD symbols are configured, and 4 frequency domain ROs are valid in each of the UL-only slots.

In some embodiments, SSBs are mapped frequency first and time second in a continuous fashion within a given symbol type, i.e., separate mapping for SBFD symbols vs. UL-only symbols. This is in contrast to Embodiment #3 in which the symbol type does not affect the mapping order. The separate mapping is illustrated in FIG. 30 with the numbering (for SBFD symbols) shown in the columns with only two rows and with numbering (for UL-only symbols) shown in the columns with four rows.

An advantage of separate mapping is that it may be ensured that for a given setting of ssb-perRACH-OccasionAndCB-PreamblesPerSSB, all SSB indices will be mapped to the UL-only symbols. This is in contrast to the example in Embodiment #3 where only SSB indices 5, 6, 7, and 8 are mapped to UL-only symbols. An advantage of mapping all SSB indices to UL-only symbols is that these symbols are generally more robust since they do not suffer from self-interference, as compared to SBFD symbols for which the gNB may transmit at the same time as attempting to receive a WD's PRACH transmission.

### Group D Embodiments (Preamble Received Power)

In the following embodiments, different ways of configuring the preamble received target power are disclosed. Common for the embodiments is that the preamble received target power is configured differently for preamble transmissions in SBFD and UL-only symbols.

An advantage with separately configured preamble received target power is that SBFD symbols that might suffer from self-interference may be configured with a higher preamble transmission received power than UL-only slots, thus compensating for the higher interference.

### Embodiment #D-1 (Explicit Parameters for SBFD Symbols)

This embodiment may include the following aspects for ROs in SBFD symbols:
A new RRC parameter is defined to indicate the preamble received target power for ROs in SBFD symbols, e.g., preambleReceivedTargetPower2; and/or
The WD uses preambleReceivedTargetPower2 to compute its transmission power when transmitting preambles in ROs in SBFD symbols.

### Embodiment #D-2 (Offset Relative to UL-Only Symbols)

This embodiment may include the following aspects for ROs in SBFD symbols:
A new RRC parameter is defined to indicate the an offset preamble received target power for ROs in SBFD symbols, e.g., preambleReceivedTargetPowerOffset; and/or
The WD uses preambleReceivedTargetPower+preambleReceivedTargetPowerOffset instead of only preambleReceivedTargetPower to compute its transmission power when transmitting preambles in ROs in SBFD symbols.

Some embodiments may include one or more of the following

Embodiment A1. A network node configured to communicate with a wireless device (WD), the network node configured to, and/or comprising a radio interface and/or comprising processing circuitry configured to:
determine a validity of a random access channel, RACH, occasion, RO, based at least in part on whether the RO occasion is contained within an uplink, UL, subband; and map synchronization signal block, SSB, indices to ROs determined to be valid.

Embodiment A2. The network node of Embodiment A1, wherein the mapping includes mapping in a frequency-first/time-second manner over all ROs, regardless of symbol type.

Embodiment A3. The network node of Embodiment A1, wherein the mapping includes mapping to a subband frequency domain, SBFD, symbols and UL-only symbols.

Embodiment A4. The network node of any of Embodiments A1 and A2, wherein the network node, radio interface and/or processing circuitry are configured to configure the WD to perform random access in first subband frequency domain, SBFD, symbols and UL-only symbols.

Embodiment A5. The network node of Embodiment A4, wherein determining the validity of an RO includes determining whether the RO is within one of subband frequency domain, SBFD, symbols and UL-only symbols.

Embodiment B1. A method implemented in a network node, the method comprising:
determining a validity of a random access channel, RACH, occasion, RO, based at least in part on whether the RO occasion is contained within an uplink, UL, subband;
   mapping synchronization signal block, SSB, indices to ROs determined to be valid.

Embodiment B2. The method of Embodiment B1, wherein the mapping includes mapping in a frequency-first/time-second manner over all ROs, regardless of symbol type.

Embodiment B3. The method of Embodiment B1, wherein the mapping includes mapping to a subband frequency domain, SBFD, symbols and UL-only symbols.

Embodiment B4. The method of any of Embodiments B1 and B2, further comprising configuring the WD to perform random access in first subband frequency domain, SBFD, symbols and UL-only symbols.

Embodiment B5. The method of Embodiment B4, wherein determining the validity of an RO includes determining whether the RO is within one of subband frequency domain, SBFD, symbols and UL-only symbols.

Embodiment C1. A wireless device, WD, configured to communicate with a network node, the WD configured to, and/or comprising a radio interface and/or comprising processing circuitry configured to:
receive from the network node, a configuration of random access channel, RACH, occasions, ROs; and
perform random access in first subband frequency domain, SBFD, symbols and uplink (UL)-only symbols.

Embodiment C2. The WD of Embodiment C1, wherein the WD, radio interface and/or processing circuitry are configured to determine a resource block, RB, offset base at least in part on a size of a subband associated with the SBFD symbols and the UL-only symbols.

Embodiment D1. A method in a wireless device, WD, configured to communicate with a network, node, the method comprising:
receiving from the network node, a configuration of random access channel, RACH, occasions, ROs; and
performing random access in first subband frequency domain, SBFD, symbols and uplink (UL)-only symbols.

Embodiment D2. The method of Embodiment D1, further comprising determining a resource block, RB, offset base at least in part on a size of a subband associated with the SBFD symbols and the UL-only symbols.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A wireless device configured to communicate with a network node, the wireless device configured to:
receive frequency domain configuration information and time domain configuration information indicating a plurality of subband full duplex, SBFD, symbols and a plurality of uplink-, UL-, only symbols in a time division duplex, TDD, configuration; and
determine a validity of a random access channel, RACH, occasion, RO, based on whether a validity condition is met, the RO being positioned in at least one SBFD symbol of the plurality of SBFD symbols or in at least one UL-only symbol of the plurality of UL-only symbols.

2. The wireless device (22) of claim 1, wherein the validity condition defines that the RO is valid based on the RO being positioned within the at least one SBFD symbol or within the at least one UL-only symbol.

3. The wireless device (22) of claim 1, wherein the validity condition indicates the RO is valid based on:
the RO being contained within a bandwidth of an UL subband of the at least one SBFD symbol; or
all configured ROs in the at least one SBFD symbol being contained within a bandwidth of an UL subband of the at least one SBFD symbol.

4. (canceled)

5. The wireless device of claim 1, wherein the wireless device is further configured to:
receive a first parameter indicating a number of ROs in the frequency domain within the at least one SBFD symbol, and
receive a second parameter indicating a resource block, RB, start index for the RO in the frequency domain within the at least one SBFD symbol.

6. (canceled)

7. The wireless device of claim 5, wherein the first parameter is applicable to both the at least one SBFD symbol and the at least one UL-only symbol, and the second parameter is applicable only to the at least one SBFD symbol-, or
the first parameter and second parameter are applicable only to the at least one SBFD symbol, and not the at least one UL-only symbol.

8.-10. (canceled)

11. The wireless device of claim 5, wherein the second parameter is an RB offset relative to a starting RB of an UL subband within the at least one SBFD symbol.

12.-15. (canceled)

16. The wireless device of claim 1, wherein the wireless device is further configured to map a plurality of SSBs to a plurality of valid ROs that meet the validity condition, the plurality of valid ROs including all valid ROs within the plurality of UL-only symbols of the TDD configuration and all valid ROs within the plurality of SBFD symbols of the TDD configuration, the mapping comprising:
a first mapping configured to map SSBs in order of increasing SSB index in a continuous manner to valid ROs within only the plurality of UL-only symbols in the TDD configuration in order of increasing frequency and then in increasing time; and
a second mapping configured to map SSBs in order of increasing SSB index in a continuous manner to valid ROs within only the plurality of SBFD symbols in the TDD configuration in order of increasing frequency and then in increasing time.

17. The wireless device of claim 1, wherein the wireless device is further configured to receive one or both of:
an indication of a preamble received target power for at least one RO in the at least one SBFD symbol;
an indication of an offset preamble received target power for at least one RO in the at least one SBFD symbol.

18. (canceled)

19. (canceled)

20. A method implemented by a wireless device that is configured to communicate with a network node, the method comprising:
receiving frequency domain configuration information and time domain configuration information indicating a plurality of subband full duplex, SBFD, symbols and a plurality of uplink-, UL-, only symbols in a time division duplex, TDD, configuration; and
determining a validity of a random access channel, RACH, occasion, RO, based on whether a validity condition is met, the RO being positioned in at least one SBFD symbol of the plurality of SBFD symbols or in at least one UL-only symbol of the plurality of UL-only symbols.

21.-38. (canceled)

39. A network node configured to communicate with a wireless device, the network node configured to:
transmit frequency domain configuration information and time domain configuration information indicating a plurality of subband full duplex, SBFD, symbols and a plurality of uplink-, UL-, only symbols in a time division duplex, TDD, configuration; and
receive physical random access channel, PRACH, signaling in a random access channel occasion, RO that meets a validity condition, the RO being positioned in at least one SBFD symbol of the plurality of SBFD symbols or in at least one UL-only symbol of the plurality of UL-only symbols.

40. The network node of claim 39, wherein the validity condition defines that the RO is valid based on the RO being positioned within the at least one SBFD symbol or within the at least one UL-only symbol.

41. The network node of claim 39, wherein the validity condition indicates the RO is valid based on:
the RO being contained within a bandwidth of an UL subband of the at least one SBFD symbol, or
all configured ROs in the at least one SBFD symbol being contained within a bandwidth of an UL subband of the at least one SBFD symbol.

42. (canceled)

43. The network node of claim 39, wherein the network node is further configured to:
transmit a first parameter indicating a number of ROs in the frequency domain within the at least one SBFD symbol; and
transmit a second parameter, that indicates a resource block, RB, start index for the RO in the frequency domain within the at least one SBFD symbol.

44.-50. (canceled)

51. The network node of claim 39, wherein the network node is further configured to map a plurality of SSBs to a plurality of valid ROs that meet the validity condition, the plurality of valid ROs including all valid ROs within the plurality of UL-only symbols of the TDD configuration and all valid ROs within the plurality of SBFD symbols of the TDD configuration, the mapping comprising mapping SSBs in order of increasing SSB index in a continuous manner to valid ROs in order of increasing frequency and then in increasing time.

52. The network node of claim 39, wherein the network node is further configured to map a plurality of SSBs to a plurality of valid ROs that meet the validity condition, the plurality of valid ROs including all valid ROs within the plurality of UL-only symbols of the TDD configuration and all valid ROs within the plurality of SBFD symbols of the TDD configuration, the mapping comprising:
a first mapping configured to map SSBs in order of increasing SSB index in a continuous manner to valid ROs within only the plurality of UL-only symbols in the TDD configuration in order of increasing frequency and then in increasing time; and
a second mapping configured to map SSBs in order of increasing SSB index in a continuous manner to valid ROs within only the plurality of SBFD symbols in the TDD configuration in order of increasing frequency and then in increasing time.

53. The network node of claim 39, wherein the network node is further configured to indicate one or both of:
a preamble received target power for at least one RO in the at least one SBFD symbol;
an offset preamble received target power for at least one RO in the at least one SBFD symbol.

54. (canceled)

55. (canceled)

56. A method implemented by a network node that is configured to communicate with a wireless device, the method comprising:
transmitting frequency domain configuration information and time domain configuration information indicating a plurality of subband full duplex, SBFD, symbols and a plurality of uplink-, UL-, only symbols in a time division duplex, TDD, configuration; and
receiving physical random access channel, PRACH, signaling in a random access channel occasion, RO that meets a validity condition, the RO being positioned in at least one SBFD symbol of the plurality of SBFD symbols or in at least one UL-only symbol of the plurality of UL-only symbols.

57.-72. (canceled)
